(19) United States
(12) Patent Application Publication
(10) Pub. No.: US 2025/0229235 A1
(43) Pub. Date: Jul. 17, 2025

(54) DURABLE GRAPHENE OXIDE MEMBRANES COMPRISING FUNCTIONALIZED SUPPORT COMPONENTS

(71) Applicant: Via Separations, Inc., Watertown, MA (US)

(72) Inventors: Cole Joseph HARRIS, Boston, MA (US); Stephen FRAYNE, Wayland, MA (US)

(21) Appl. No.: 19/170,762

(22) Filed: Apr. 4, 2025

Related U.S. Application Data
(63) Continuation of application No. PCT/US2023/076392, filed on Oct. 9, 2023.
(60) Provisional application No. 63/414,339, filed on Oct. 7, 2022.

(51) Int. Cl. B01D 71/02; B01D 61/02; B01D 67/00; B01D 69/10; B01D 69/12

(52) U.S. Cl. CPC B01D 71/0211; B01D 61/027; B01D 67/00416; B01D 69/107; B01D 69/1214; B01D 69/1216; B01D 2311/14; B01D 2323/345; B01D 2323/385; B01D 2325/20; B01D 2325/34

(57) ABSTRACT

Filtration apparatus including Graphene Oxide (GO) membranes are described herein. The GO membranes exhibit durability under harsh operation conditions including elevated temperatures, high pressure, and/or non-neutral pH. The filtration apparatus can include a GO membrane and a functionalized support including surface functional groups grafted to the functionalized support via a free radical co-polymerization approach. The filtration apparatus can exhibit improved performance (e.g., high rejection) in applications such as pulp and paper processing, which facilitates achieving permeate quality targets. The filtration apparatus described herein can also offer a more stable replacement for reverse osmosis membranes which are known to degrade under strongly alkaline conditions and high temperatures.

### CROSS-REFERENCE TO RELATED APPLICATIONS

This application is a continuation of International Patent Application No. PCT/US2023/076392, entitled “Durable Graphene Oxide Membranes Comprising Functionalized Support Components,” filed Oct. 9, 2023, which claims the benefit of U.S. Provisional application Ser. No. 63/414,339, entitled “Durable Graphene Oxide Membranes Comprising Functionalized Support Components,” filed Oct. 7, 2022, the disclosures of each of which is incorporated by reference herein in its entirety.

### TECHNICAL FIELD

The present disclosure relates generally to graphene oxide membranes and their use in separation processes.

### BACKGROUND

Membranes can be used to separate a mixture by passing some components (filtrate or permeate) and retaining others preferentially with a balance of the mixture (rejects) according to any of a variety of properties of the membrane and/or of the components of the material being filtered. For example, membranes can be configured to separate rejects from a filtrate based on size exclusion (i.e., a physical barrier such as pores that are smaller than the excluded particles). Other examples include membranes that are configured to separate rejects from a filtrate based on chemical, electrochemical, and/or physical binding with one or more components of the material being filtered.

Polymer membranes are a common type of membrane. They have been used commercially in a wide range of applications including water softening, desalination, and for the concentration, removal, and purification of different salts, small molecules, and macromolecules. However, in certain environments (e.g., oxidizing conditions, high pH, high temperatures, or in some solvents), polymer membranes can become damaged or fail due to swelling, oxidation reactions, degradation, or softening of the polymer. Accordingly, there is a need in the art for new membranes that address one or more deficiencies of polymer membranes.

### SUMMARY

Embodiments described herein related generally to graphene oxide membranes with tunable rejection rate selectivity, which is useful for fluid filtration. For example, the graphene oxide membranes can be used for concentration, removal, and/or purification of different salts. Tunable rejection rate selectivity is particularly helpful for applications in the pulp and paper industry to facilitate achieving permeate quality targets, and/or as a more stable replacement for reverse osmosis membranes which are known to degrade under strongly alkaline conditions and high temperatures.

One aspect of the of the present disclosure relates to a functionalized support for separating solute species, the functionalized support including: a polymeric membrane including polyethersulfone; and a plurality of surface functional groups disposed on a surface of the polymeric membrane and covalently bound to the polyethersulfone. The performance of the functionalized support is characterized by a NaCl rejection rate of at least 70% with a 1 wt. % NaCl solution at room temperature and a pressure of about 250 psi.

In some embodiments the plurality of surface functional groups are covalently bound to the polyethersulfone via UV-induced graft polymerization of a monomer, the monomer including at least one of an allyl group, a vinyl group, a benzyl group, or a cyclic olefin.

In some embodiments the monomers include allylamine, allyl alcohol, allyl methyl ether, ethyl vinyl ether, 4-vinylbenzoic acid, acrylic acid, ethylene glycol, vinyl ether, phenyl vinyl ether, norbornene, or a combination thereof.

In some embodiments the polymeric membrane is a microporous substrate.

In some embodiments the microporous substrate has a molecular weight cutoff (MWCO) of at least 140 Da.

In some embodiments the functionalized support further includes a graphene oxide membrane disposed on a surface of the polymeric membrane, the graphene oxide membrane comprising a plurality of graphene oxide layers, each graphene oxide layer including at least one graphene oxide sheet covalently coupled to a chemical spacer.

Another aspect of the present disclosure relates to a filtration apparatus comprising: a functionalized support; and a graphene oxide membrane disposed on the functionalized support. The graphene oxide membrane comprising a plurality of graphene oxide layers, each graphene oxide layer including at least one graphene oxide sheet covalently coupled to a chemical spacer. The performance of the functionalized support is characterized by a NaCl rejection rate of at least 70% with a 1 wt. % (10,000 ppm) NaCl solution at room temperature and a predetermined pressure.

In some embodiments the functionalized support includes: a polymeric membrane including polyethersulfone; and a plurality of surface functional groups, the plurality of surface functional groups covalently bound to the polyethersulfone.

In some embodiments, the plurality of surface functional groups are covalently bound to the polyethersulfone via UV-induced graft co-polymerization of a monomer, the monomer including at least one of an allyl group, a vinyl group, a benzyl group, or a cyclic olefin.

In some embodiments, plurality of surface functional groups can include allylamine, allyl alcohol, allyl methyl ether, ethyl vinyl ether, 4-vinylbenzoic acid, acrylic acid, ethylene glycol, vinyl ether, phenyl vinyl ether, norbornene, or a combination thereof.

In some embodiments, the polymeric membrane can be a microporous polymer substrate.

In some embodiments, the microporous polymer substrate can have a molecular weight cutoff (MWCO) of at least about 140 Da.

In some embodiments, the filtration apparatus can have a permeance of at least 0.1 LMH with a 1 wt. % (10,000 ppm) NaCl solution at room temperature and a pressure of at least 200 psi

In some embodiments, the predetermined pressure is at least about 200 psi and no more than 1200 psi.

In some embodiments, each of the graphene oxide sheets is not covalently crosslinked to an adjacent graphene oxide sheet.

In some embodiments, each of the graphene oxide sheets is covalently crosslinked to an adjacent graphene oxide sheet.

In some embodiments, the chemical spacer comprises an amine or a derivative thereof.

In some embodiments, the chemical spacer comprises —NH—R1, wherein R1 is an aryl, which can be optionally substituted.

In some embodiments, the amine is 4-aminophenylacetic acid or 2-(4-aminophenyl) ethanol.

In some embodiments, wherein the chemical spacer comprises an amide or a derivative thereof.

In some embodiments, wherein the chemical spacer comprises —NH—C(O)—R2, wherein R2 is C1-C6 alkyl or C2-C6 alkenyl, each of which can be optionally substituted.

In some embodiments, the amide is acrylamide, propionamide, isobutyramide, or pivalamide.

In some embodiments, the filtration apparatus further includes a chemical linker covalently coupled to the chemical spacer to crosslink each of the graphene oxide sheets to the adjacent graphene oxide sheet.

In some embodiments, the chemical linker includes one of the following structures:

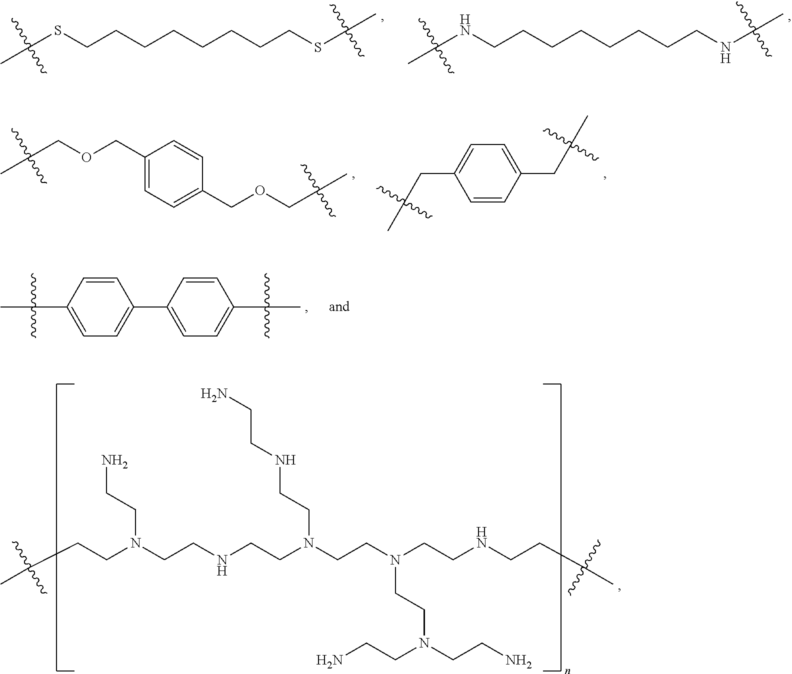

wherein:
n is 1 to 5; and [symbol]
   denotes the point of coupling to the chemical spacer.

In some embodiments, the combination of the chemical linker and the chemical spacer has the following structure: structure:

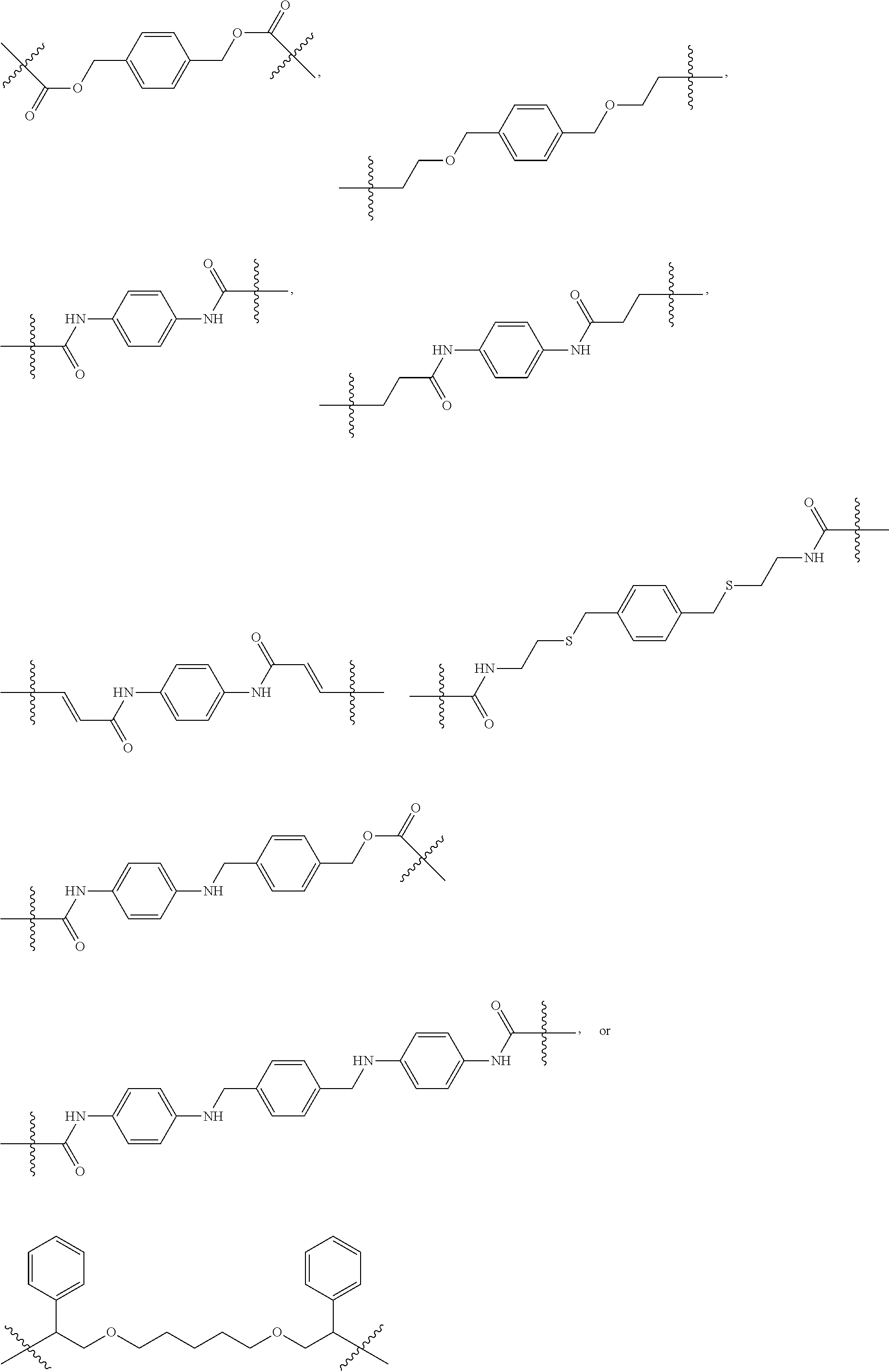

where [symbol] denotes the point of coupling with the graphene oxide sheet

Another aspect of the present disclosure relates to a method for preparing a functionalized support, the method including: exposing a support material to a cleaning solution; exposing the support material to a solution including one or more monomers; drying the support material at a predetermined temperature; and activating the support material to couple surface functional groups to the support material and produce the functionalized support.

In some embodiments, the one or more monomers include at least one of an allyl group, a vinyl group, a benzyl group, or a cyclic olefin.

In some embodiments, the activation step includes exposing the support material and the one or more monomers to Ultraviolet (UV) light for a period of time.

In some embodiments, the activation step includes exposing the support material and the one or more monomers to a corona discharge for a period of time.

In some embodiments, the activation step includes exposing the support material and the one or more monomers to an activation temperature for a period of time.

In some embodiments, the period of time is no more than about 5 min.

In some embodiments, the functionalized support is characterized by a NaCl rejection rate of at least 70% with a 1 wt. % NaCl solution at room temperature and a pressure of at least about 200 psi.

### BRIEF DESCRIPTION OF THE DRAWINGS

FIG. 1A is a schematic illustration of a filtration apparatus 1000 in accordance with some embodiments of the present disclosure.

FIG. 1B is a schematic illustration of a graphene oxide membrane 100B in accordance with some embodiments of the present disclosure. The graphene oxide membrane 100B comprises a plurality of graphene oxide sheets, wherein each of the graphene oxide sheets is not covalently crosslinked to the adjacent graphene oxide sheet.

FIG. 1C is a schematic illustration of a graphene oxide membrane 100C in accordance with some embodiments of the present disclosure. The graphene oxide membrane 100C comprises a plurality of graphene oxide sheets, wherein each of the graphene oxide sheets is covalently crosslinked to the adjacent graphene oxide sheet.

FIG. 2 shows a thermogravimetric analyzer (TGA) curve illustrating the thermal stability of example support and/or substrate materials including a polyethersulfone (PES) support, an allylamine PES functionalized support (e.g., a functionalized support including allylamine surface functional groups covalently bound to PES), and a vinyl benzoic acid PES functionalized support (e.g., a functionalized support including vinyl benzoic acid surface functional groups covalently bound to PES).

FIG. 3A is a chart showing the single solute rejection rate of various support and/or substrate materials including a PES support, a PES support having a collapsed pore structure, and an allylamine PES functionalized support (e.g., a functionalized support including allylamine surface functional groups covalently bound to PES), illustrating the separation of solute molecules of different sizes and effective charge.

FIG. 3B is a chart showing the single solute rejection rate and flux of the allylamine PES functionalized support 200 of FIG. 3A, illustrating the separation of solute molecules of different sizes and effective charge.

FIG. 4 is a chart showing the rejection rate of an allylamine PES functionalized support in diluted weak black liquor and sodium chloride, measured via conductivity and refractive index.

FIG. 5 shows a Scanning Electron Microscope (SEM) micrograph showing the microstructure, porosity, and pore size distribution of an allylamine PES functionalized support.

FIG. 6 is a flow chart of an example method for preparing a functionalized support, according to an embodiment.

FIG. 7A presents an example chemical reaction between a support material and surface functionalization reagents to produce a functionalized support, according to an embodiment.

FIG. 7B presents an example crosslinking chemical reaction between surface functional groups on a functionalized support and pendant groups present in graphene oxide sheets, according to some embodiments.

FIG. 8 is a chart showing the single solute rejection rate of various functionalized supports fabricated according to embodiments of the present disclosure.

FIG. 9 shows a chart of contact angle of a polyethersulfone (PES) support, an allyl amine PES functionalized support, and an allyl alcohol PES functionalized support

FIG. 10 is a chart showing the rejection rate of a reverse osmosis membrane and a filtration apparatus comprising a graphene oxide membrane and an allylamine PES functionalized support, according to an embodiment. The rejection rates were measured via conductivity and refractive index flowing a 1 wt. % sodium chloride (NaCl) solution.

FIG. 11 is a chart showing the rejection rate of the filtration apparatus 1000 and the reverse osmosis membrane shown in FIG. 10, in flowing a diluted weak black liquor (WBL), measured via conductivity and refractive index.

FIG. 12A is a chart showing the rejection rate and flux of a filtration apparatus comprising a propionamide graphene oxide membrane and an allylamine PES functionalized support in flowing a diluted Weak Black Liquor (WBL) feed at different operating pressures.

FIG. 12B is a chart showing the rejection rate and flux of a filtration apparatus comprising an alkylated graphene oxide membrane and an allylamine PES functionalized support in flowing a Weak Black Liquor (WBL) feed at different operating pressures.

FIG. 13 is a chart displaying a comparison of the performance (e.g., rejection rate and flux) expected from a filtration apparatus comprising a propionamide graphene oxide membrane and an allylamine PES functionalized support when operating as part of a first filtration pass, a second filtration pass, and a third filtration pass.

### DETAILED DESCRIPTION

Graphite is a crystalline form of carbon with its atoms arranged in a hexagonal structure layered in a series of planes. Due to its abundance on earth, graphite is very cheap and is commonly used in pencils and lubricants. Graphene is a single, one atomic layer of carbon atoms (i.e., one of the layers of graphite) with several exceptional electrical, mechanical, optical, and electrochemical properties, earning it the nickname “the wonder material.” To name just a few, it is highly transparent, extremely light and flexible yet robust, and an excellent electrical and thermal conductor. Such extraordinary properties render graphene and related thinned graphite materials (e.g., few layer graphene) as promising candidates for a diverse set of applications. For example, graphene can be used in coatings to prevent steel and aluminum from oxidizing, and to filter salt, heavy metals, and oil from water.

Graphene oxide is an oxidized form of graphene having oxygen-containing pendant functional groups (e.g., epoxide, carboxylic acid, or hydroxyl) that exist in the form of single atom thick sheets. By oxidizing the graphene in graphite, graphene oxide sheets can be produced. For example, the graphene oxide sheets can be prepared from graphite using a modified Hummers method. Flake graphite is oxidized in a mixture of KMnO₄, H₂SO₄, and/or NaNO₃, then the resulting pasty graphene oxide is diluted and washed through cycles of filtration, centrifugation, and resuspension. The washed graphene oxide suspension is subsequently ultrasonicated to exfoliate graphene oxide particles into graphene oxide sheets and centrifuged at high speed to remove unexfoliated graphite residues. The resulting yellowish/light brown solution is the final graphene oxide sheet suspension. This color indicates that the carbon lattice structure is distorted by the added oxygenated functional groups. The produced graphene oxide sheets are hydrophilic and can stay suspended in water for months without a sign of aggregation or deposition

Due in part for its low cost, high chemical stability, strong hydrophilicity, and compatibility with a variety of environments, graphene oxide has been explored for its use as membranes in filtration applications. For example, as compared to polymer membranes, which can be prone to oxidation, graphene oxide membranes can remain stable under oxidizing conditions. However, existing graphene oxide membranes are plagued by durability issues when exposed to high temperatures or acidic/basic conditions. For example, some existing graphene oxide membranes can achieve high rejection rates when used in reverse osmosis applications at room temperature. However, after exposure to high temperatures (e.g., greater than about 50° C.) and/or highly alkaline pH environments (e.g., pH=11) for a period of time, the performance of these graphene oxide membranes diminishes. The present disclosure provides filtration devices and graphene oxide membranes that address the limitations of current graphene oxide membranes and exhibit one or more superior properties over existing graphene oxide membranes. At least by incorporating to the graphene oxide membrane a functionalized support which comprises chemical functional groups, the present disclosure provides filtration devices and graphene oxide membranes having improved rejection rates and stability under high temperatures and/or highly alkaline pH environments.

### Filtration Apparatus

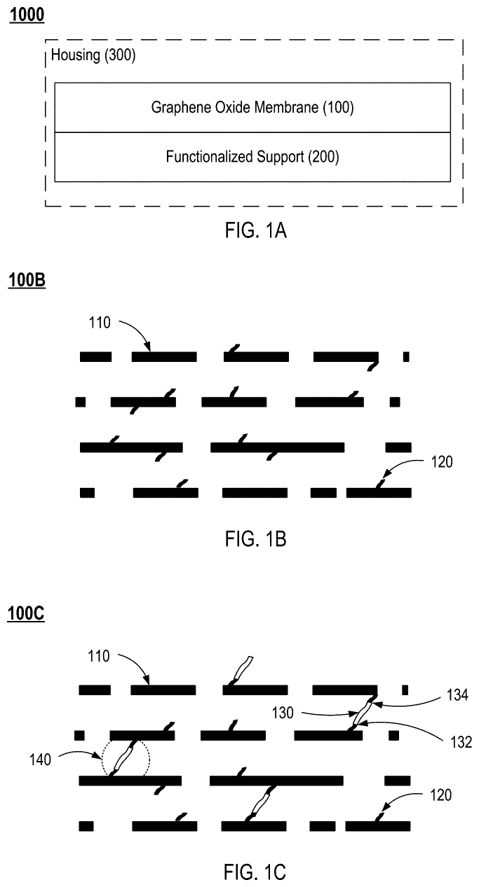

FIG. 1A shows a schematic illustration of a filtration apparatus 1000 according to the present disclosure. The filtration apparatus 1000 includes a graphene oxide membrane 100, a functionalized support 200, and optionally a housing 300. The graphene oxide membrane 100 can be disposed on the functionalized support 200, and the optional housing 300 can enclose the functionalized support 200 and the graphene oxide membrane 100.

In some embodiments, the graphene oxide membrane 100 and the functionalized support 200 can have a combined thickness of about 50 μm to about 1300 μm, about 100 μm to about 750 μm, about 200 μm to about 1000 μm, or about 200 μm to about 1200 μm, inclusive of all values and ranges therebetween.

In some embodiments, the filtration apparatus 1000 can comprise a plurality of flat polymer sheets combined to form a spiral filtration module. For example, in some embodiments, a spiral filtration module can comprise a plurality of flat polymer sheets stacked atop one another, and the plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel.

In some embodiments, the filtration apparatus 1000 includes about 0.1 mg to 6 mg of the graphene oxide membrane 100 per 5000 mm². In some embodiments, the filtration apparatus 1000 includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the graphene oxide membrane 100 per 5000 mm². For example, the filtration apparatus 1000 can include about 1 mg, about 1.5 mg, about 2 mg, about 2.5 mg, or about 3 mg of the graphene oxide membrane 100 per 5000 mm².

FIG. 1B shows a schematic diagram of a graphene oxide membrane 100B, according to some embodiments. The graphene oxide membrane 100B includes a plurality of graphene oxide sheets 110 and a plurality of chemical spacers 120. Each of the graphene oxide sheets 110 is not covalently crosslinked to the adjacent graphene oxide sheet 110.

FIG. 1C shows a schematic diagram of a graphene oxide membrane 100C, according to some embodiments. The graphene oxide membrane 100C includes a plurality graphene oxide sheets 110, a plurality of chemical spacers 120, and a plurality of chemical linkers 130. As shown in FIG. 1C, in some embodiments, the graphene oxide sheets 110 can optionally be coupled to an adjacent graphene oxide sheet 110 via at least one chemical linker 130, wherein the chemical linker 130 is covalently coupled to the chemical spacer 120 on each graphene oxide sheet 110.

The graphene oxide sheets 110 can include flakes. The flakes can have an aspect ratio (on the plane of the graphene oxide sheets 110). In some embodiments, the aspect ratio can be less than about 250,000:1, less than about 100,000:1, less than about 50,000:1, less than about 25,000:1, less than about 10,000:1, less than about 5,000:1, less than about 1,000:1. In some embodiment, the flakes can have an aspect ratio of at least about 100:1, at least about 200:1, at least about 300:1, at least about 400:1, or at least about 500:1, inclusive of all values and ranges therebetween.

In some embodiments, the size of the space between graphene oxide sheets 110 is the d-spacing, which can be measured by X-ray diffraction such as grazing incidence X-ray diffraction (GIXRD). In some embodiments, the d-spacing for dried graphene oxide sheets 110 can be less than about 20 Å, less than about 15 Å, or less than about 10 Å, inclusive of all values and ranges therebetween. In some embodiments, the d-spacing for dried graphene oxide sheets 110 can be in the range of about 5 Å to about 20 Å, about 5 Å to about 15 Å, about 8 Å to about 20 Å, about 8 Å to about 15 Å, inclusive of all values and ranges therebetween. In some embodiments, the d-spacing for dried graphene oxide sheets 110 can be about 17 Å, about 16 Å, about 15 Å, about 14 Å, about 13 Å, about 12 Å, about 11 Å, about 10 Å, about 9 Å, about 8 Å, or about 7 Å. The length of the chemical spacer 120 can be an important factor in controlling the d-spacing. The length of the chemical linker 130 can also be an important factor in controlling the d-spacing.

In some embodiments, the graphene oxide membrane 100 can include at least about 100 layers, at least about 125 layers, at least about 150 layers, at least about 200 layers, at least about 225 layers, at least about 250 layers of graphene sheets, inclusive of all values and ranges therebetween. In some embodiments, the graphene oxide membrane 100 can include no more than about 600 layers, no more than about 550 layers, no more than about 500 layers, no more than about 450 layers, no more than about 400 layers, no more than about 350 layers, or no more than about 300 layers of graphene oxide sheets, inclusive of all values and ranges therebetween.

Combinations of the above-referenced ranges for the number of layers in the graphene oxide membrane 100 are also possible (e.g., at least about 100 to less than about 600, or at least about 300 to less than about 600), inclusive of all values and ranges therebetween.

In some embodiments, the graphene oxide membrane 100 can include about 100 to 600 layers of graphene oxide sheets, e.g., 200-500 layers, 200-400 layers, 200-300 layers, 200-250 layers, 300-600 layers, 300-500 layers, or 300-400 layers.

In some embodiments, the graphene oxide membrane 100 can have a thickness greater than or equal to about 25 nm, greater than or equal to about 50 nm, greater than or equal to about 0.1 microns, greater than or equal to about 0.15 microns, greater than or equal to about 0.2 microns, greater than or equal to about 0.3 microns, greater than or equal to about 0.4 microns, greater than or equal to about 0.5 microns, greater man or equal to about 0.75 microns, greater than or equal to about 1 micron, greater than or equal to about 2 microns. In some embodiments, the thickness of the graphene oxide membrane 100 may be less than or equal to about 5 microns, less than or equal to about 1 micron, less than or equal to about 0.75 microns, less than or equal to about 0.5 microns.

Combinations of the above-referenced ranges for the thickness of the graphene oxide membrane 100 are also possible (e.g., greater than or equal to about 25 nm to less than or equal to about 5 microns, greater than or equal to about 0.15 microns to less than or equal to about 0.5 microns).

In some embodiments, embodiments, the graphene oxide membrane 100 can have an average pore size of greater than or equal to about 0.5 nm, greater than or equal to about 1 nm, greater than or equal to about 2 nm, greater than or equal to about 3 nm, greater than or equal to about 4 nm, or greater than or equal to about 5 nm. In some embodiments, the graphene oxide membrane 100 can have an average pore size of less than or equal to about 6 nm, less than or equal to about 5 nm, less than or equal to about 4 nm, less than or equal to about 3 nm, or less than or equal to about 2 nm, inclusive of all values and ranges therebetween.

Combinations of the above-referenced ranges for the average pore size are also possible (e.g., greater than or equal to about 0.5 nm to less than or equal to about 6 nm, greater than or equal to about 1 nm to less than or equal to about 6 nm). In some embodiments, the graphene oxide membrane 100 can have an average pore size of about 0.5 nm, about 0.8 nm, about 1 nm, about 2 nm, about 3 nm, about 4 nm, about 5 nm, or about 6 nm.

In some embodiments, the graphene oxide sheets 110 can be arranged and oriented generally parallel to each other.

The spacing between the graphene oxide sheets 110 can be either interlayer spacing or intralayer spacing. The spacing between the graphene oxide sheets 110 can be engineered to control the molecular weight cutoff of the graphene oxide membrane 100.

In some embodiments, the chemical spacer 120 can form a covalent bond with an oxygen-containing functional group on the graphene oxide sheet 110. For example, the chemical spacer 120 can form a covalent bond with the epoxide groups, carboxylic groups or hydroxyl groups on the graphene oxide. In some embodiments, the chemical spacer 120 can also form a covalent bond with a non-oxygen-containing group (e.g., amine) on the graphene oxide sheet 110.

In some embodiments, the chemical spacer 120 can form a noncovalent interaction with an adjacent graphene oxide sheet 110 through a variety of mechanisms. In some embodiments, the chemical spacer 120 can be coupled to the adjacent graphene oxide sheet 110 through an ionic interaction. In some embodiments, the chemical spacer 120 can be coupled to the adjacent graphene oxide sheet 110 through hydrogen bonding. In some embodiments, the chemical spacer 120 can be coupled to the adjacent graphene oxide sheet 110 through one or more Van der Waals forces. In some embodiments, the chemical spacer 120 can be coupled to the adjacent graphene oxide sheet 110 through one or more π-effects. In some embodiments, the chemical spacer 120 can be coupled to the adjacent graphene oxide sheet 110 through the hydrophobic effect.

In some embodiments, the chemical spacer 120 can include an amine or a derivative thereof. In some embodiments, the chemical spacer 120 can have the structure in accordance with Formula I:

—NH—R₁ (I),

wherein: R1 is an aryl or heteroaryl, which can be optionally substituted. In some embodiments, R₁ is

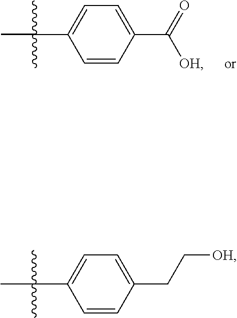 [SMILES: *c1ccc(C(=O)O)cc1 ; *c1ccc(CCO)cc1]

where denotes the point of coupling with —NH.

In some embodiments, the chemical spacer 120 can include 4-aminophenylacetic acid, 2-(4-aminophenyl) ethanol, 2-(4- [symbol] aminophenyl) propanol, 2-(4-aminophenyl) butanol, or any combination thereof.

In some embodiments, the chemical spacer 120 can include an amide or a derivative thereof. In some embodiments, the chemical spacer 120 can include the structure in accordance with Formula II:

—NH—C(O)—R₂ (II),

wherein: R₂ is a C₁-C₁₀ alkyl or a C₂-C₁₀ alkenyl, each of which can be optionally substituted. In some embodiments, R₂ is a C₁-C₈alkyl, C₁-C₆ alkyl, C₂-C₅ alkenyl, or C₂-C₆ alkenyl. In some embodiments, non-limiting examples of R₂ can include methyl, ethyl, n-propyl, isopropyl, n-butyl, isobutyl, sec-butyl, tert-butyl, pentyl, hexyl, heptyl, octyl, nonyl, decyl, ethenyl, propenyl, and butenyl.

In some embodiments, the chemical spacer 120 can include acrylamide, propionamide, isobutyramide, pivalamide, or any combination thereof.

In some embodiments, the chemical spacer 120 can include a carbamate or a derivative thereof. In some embodiments, the chemical spacer 120 can include the structure in accordance with Formula Iia:

—NH—C(O)—O—R₃ (Iia),

wherein: R₃ is a C₁-C₁₀ alkyl, a C₂-C₁₀ alkenyl, C₄-C₁₀ heterocycloalkyl, C₄-C₁₀ cycloalkyl, alkylaryl, aryl, or heteroaryl, each of which can be optionally substituted. In some embodiments, R₃ is a C₁-C₈ alkyl, C₁-C₆ alkyl, C₂-C₅ alkenyl, C₂-C₆ alkenyl, phenyl, or methylphenyl. In some embodiments, R₃ is methyl, ethyl, n-propyl, isopropyl, n-butyl, isobutyl, sec-butyl, tert-butyl, pentyl, hexyl, heptyl, octyl, nonyl, decyl, ethenyl, propenyl, or butenyl.

In some embodiments, non-limiting examples of the chemical spacer 120 can include methyl carbamate, ethyl carbamate, propyl carbamate, butyl carbamate, tert-butyl carbamate, phenyl carbamate, and benzyl carbamate.

In some embodiments, the weight ratio of graphene oxide sheets 110 to chemical spacer 120 in the graphene oxide membrane 100 can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of graphene oxide sheets 110 to chemical spacer 120 in the graphene oxide membrane 100 can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

In some embodiments, the atomic percent (at %) content of nitrogen present on the surface of the graphene oxide membrane 100 measured by X-Ray photoelectron spectroscopy can be less than about 5.0 at %, less than about 4.5 at %, less than about 4.0 at %, less than about 3.5 at %, less than about 3.2 at %, less than about 3.0 at %, less than about 2.8 at %, less than about 2.6 at %, less than about 2.4 at %, less than about 2.2 at %, less than about 2.0 at %, inclusive of all values and ranges therebetween. In some embodiments, the atomic percent (at %) content of nitrogen present on the surface of the graphene oxide membrane 100 measured by X-Ray photoelectron spectroscopy can be at least about 0.6 at %, at least about 1.1 at %, at least about 1.2 at %, at least about 1.3 at %, at least about 1.4 at %, at least about 1.5 at %, at least about 1.6 at %, at least about 1.8 at %, at least about 2.0 at %, inclusive of all values and ranges therebetween.

Combinations of the above referenced ranges for the at % content of nitrogen are also possible (e.g., at least about 0.6 at % to less than about 5.0 at %, or at least about 1.1 at % to less than about 3.2 at %).

In some embodiments, the atomic percent (at %) content of carbon present on the surface of the graphene oxide membrane 100 measured by X-Ray photoelectron spectroscopy can be less than about 80%, less than about 78%, less than about 75%, inclusive of all values and ranges therebetween. In some embodiments, the at % content of carbon present on the surface of the graphene oxide membrane 100 measured by X-Ray photoelectron spectroscopy can be at least about 50%, at least about 55%, or at least about 60%, inclusive of all values and ranges therebetween.

Combinations of the above referenced ranges for the at % content of carbon are also possible (e.g., at least about 50% to less than about 80%, or at least about 60% to less than about 75%). In contrast, existing graphene oxide membranes that are deliberately or unintentionally reduced often have at % content of carbon greater than 80% or even greater than 95%.

As described above with reference to FIG. 1C, in some embodiments the graphene oxide sheets 110 can optionally be coupled to an adjacent graphene oxide sheet 110 via at least one chemical linker 130. In some embodiments, the graphene oxide sheets 110 can be arranged and oriented generally parallel to each other and each of the graphene oxide sheets 110 can be coupled to an adjacent graphene oxide sheet 110 via a chemical linker 130.

The chemical linker 130 can be either linear or branched. In some embodiments, the chemical linkers 130 coupling adjacent graphene oxide sheets 110 can include a combination of linear and branched structures. In some embodiments, the length of the chemical linker 130 may be selected to impart desirable properties and/or control the spacing between the graphene oxide sheets 110. The spacing between the graphene oxide sheets 110 can be either interlayer spacing or intralayer spacing. The spacing between the graphene oxide sheets 110 can be engineered to control the molecular weight cutoff of the graphene oxide membrane 100.

The chemical linker 130 can have at least two ends that are coupled to adjacent graphene oxide sheets 110. For example, as shown in FIG. 1C, the chemical linker can include a first end 132 coupled to a first chemical spacer on a first graphene oxide sheet and a second end 134 coupled to a second chemical spacer on a second graphene oxide sheet. The first end 132 can be coupled to the first chemical spacer through a covalent bond or a noncovalent interaction. The second end 134 can be coupled to the second chemical spacer through a covalent bond or a noncovalent interaction. In some embodiments, an end of the chemical linker 130 (e.g., the first end 132, the second end 134, or another end) may be dangling, i.e., not coupled to anything.

In some embodiments, the chemical linker 130 can form a covalent bond with the oxygen-containing functional groups on the chemical spacer 120. For example, the chemical linker 130 can form a covalent bond with an epoxide group, a carboxylic group, or a hydroxyl group on the chemical spacer 120. In some embodiments, the chemical linker 130 can also form a covalent bond with a non-oxygen-containing group (e.g., amine) on the chemical space 120. In some embodiments, the chemical linker 130 can also form a covalent bond with a carbon atom on the chemical spacer 120.

The combination of the chemical spacer 120 and the chemical linker 130 that is coupled thereto is referred to herein as the crosslinker 140.

In some embodiments, the crosslinker 140 can have a structure in accordance with Formula III:

R₄-A-R₅ (III)
wherein: A is absent, aryl, heteroaryl, C₁-C₁₀ alkylene linker, C₂-C₁₀ alkenylene linker, or (—CH₂—CH₂—O—)ₚ (p=1 to 5), each of which can be optionally substituted; and
R₄ and R₅ are independently selected from C₁-C₁₀ alkyl, C₁-C₁₀ alkenyl, C₁-C₁₀ hydroxyalkyl, —C₀-C₆ alkyl-C(O)—O—C₀-C₆ alkyl, —C(O)—O—C₁-C₁₀ alkyl, —C₀-C₆ alkyl-C(O)—S—C₀-C₆ alkyl, —C(O)—S—C₁-C₁₀ alkyl, —C₀-C₆ alkyl-O—C₀-C₆ alkyl, —O—C₁-C₁₀ alkyl, —C₀-C₆ alkyl-S—C₀-C₆ alkyl, —S—C₁-C₁₀ alkyl, —C₀-C₆ alkyl-NH—C₀-C₆ alkyl, —NH—, —NH—(C₁-C₁₀ alkyl)₂, —NH—C₁-C₁₀ alkyl, —C₀-C₆ alkyl-NH—C(O)—C₀-C₆ alkyl, —NH—C(O)—C₁-C₁₀ alkyl, and (—CH₂—CH₂—O—)ₚ (p=1 to 5), each of which can be optionally substituted, wherein one end of each of R₄ and R₅ can be optionally coupled to a graphene oxide sheet. In some embodiments, the alkyl, alkenyl, or hydroxyalkyl in R₄ and/or R₅ can be optionally coupled to a graphene oxide sheet.

In some embodiments, A is phenyl, biphenyl, naphthyl, or

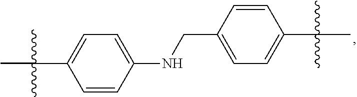 [SMILES: *c1ccc(CNc2ccc(*)cc2)cc1]

where [symbol] denotes the point of coupling with R₄ or R₅.

In some embodiments, A is a C₁-C₆ alkylene linker or a C₂-C₆ alkenylene linker, each of which can be optionally substituted.

In some embodiments, A is absent.

In some embodiments, R₄ and R₅ independently includes an ether, amine, amide, thioether, or a combination thereof.

In some embodiments, R₄ and R₅ are independently selected from —(CH₂)₁₋₁₀O—, —(CH₂)₁₋₁₀OC(O)—, —(CH₂)₀₋₆—NH—C(O)—(CH₂)₀₋₆—, —(CH₂)₀₋₆—O—(CH₂)₀₋₆—, —(CH₂)₀₋₆—S—(CH₂)₀₋₆—, or —NH—, each of which can be optionally substituted.

In some embodiments, R₄ and R₅ are independently C₁-C₁₀ hydroxyalkyl, which can be optionally substituted, and the hydroxyalkyl can be optionally coupled to a graphene oxide sheet.

In some embodiments, R₄ and R₅ are independently —NH—, —NH—C(O)—, —NH—C(O)—(CH₂)₂—O—, —CH₂—NH-phenyl-HN—C(O)—, —CH₂—S—(CH₂)₂—NH—C(O)—, or —CH₂—O—C(O)—.

In some embodiments, R₄ and R₅ are independently —C₁-C₆ alkyl-O—C₁-C₆ alkyl, which can be optionally substituted, and the alkyl can be optionally coupled to a graphene oxide sheet.

In some embodiments, R₄ and R₅ are independently —NH—C(O)—C₁-C₁₀ alkyl, which can be optionally substituted, and the alkyl can be optionally coupled to a graphene oxide sheet. For example, R₄ and R₅ can be independently —NH—C(O)—(CH₂)_{q}—O— (q=1 to 10).

In some embodiments, the crosslinker 140 can have a structure in accordance with Formula IIIa:

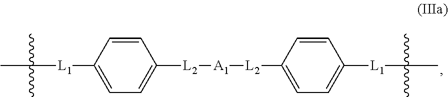

wherein:
L₁ is selected from —NH—, —C(═O)—NH—, or absent;
L₂ is selected from absent, —C(═O)—NH—(CH₂)ₙ—, —(CH₂)₂—O—(CH₂)ₙ—, or —NH—(CH₂)ₙ—;
A₁ is selected from absent, aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
n is 0-4; and
[symbol] denotes the point of coupling with a carbon atom on a graphene oxide sheet.

In some embodiments, A₁ is phenyl. For example, the crosslinker 140 can have a structure in accordance with Formula IIIa-1:

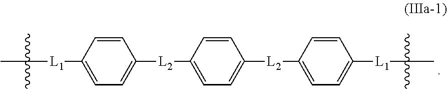

In some embodiments, A₁ is linear C₅ alkyl. In some embodiments, A₁ is linear C₆ alkyl.

In some embodiments, n is 0. In some embodiments, n is 1. In some embodiments, n is 2. In some embodiments, n is 3. In some embodiments, n is 4.

In some embodiments, the crosslinker 140 can have a structure in accordance with Formula IIIb:

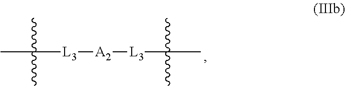

wherein:
L₃ is selected from —C(═O)—NH—(CH₂)ₘ—, —C(═O)—NH—C(═O)—(CH₃)₂—S—(CH₂)ₘ—, or —NH—C(═O)—(CH₃)₂—S—(CH₂)ₘ—;
A₂ is selected from aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
m is 0-4; and
[symbol] denotes the point of coupling with a carbon atom on a graphene oxide sheet.

In some embodiments, A₂ is phenyl. For example, the crosslinker 140 can have a structure in accordance with Formula IIIb-1:

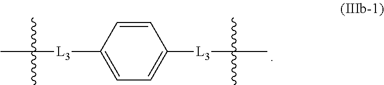

In some embodiments, A₂ is linear C₅ alkyl. In some embodiments, A₂ is linear C₆ alkyl.

In some embodiments, m is 0. In some embodiments, m is 1. In some embodiments, m is 2. In some embodiments, m is 3. In some embodiments, m is 4.

In some embodiments, the crosslinker 140 can have one of the following structures:

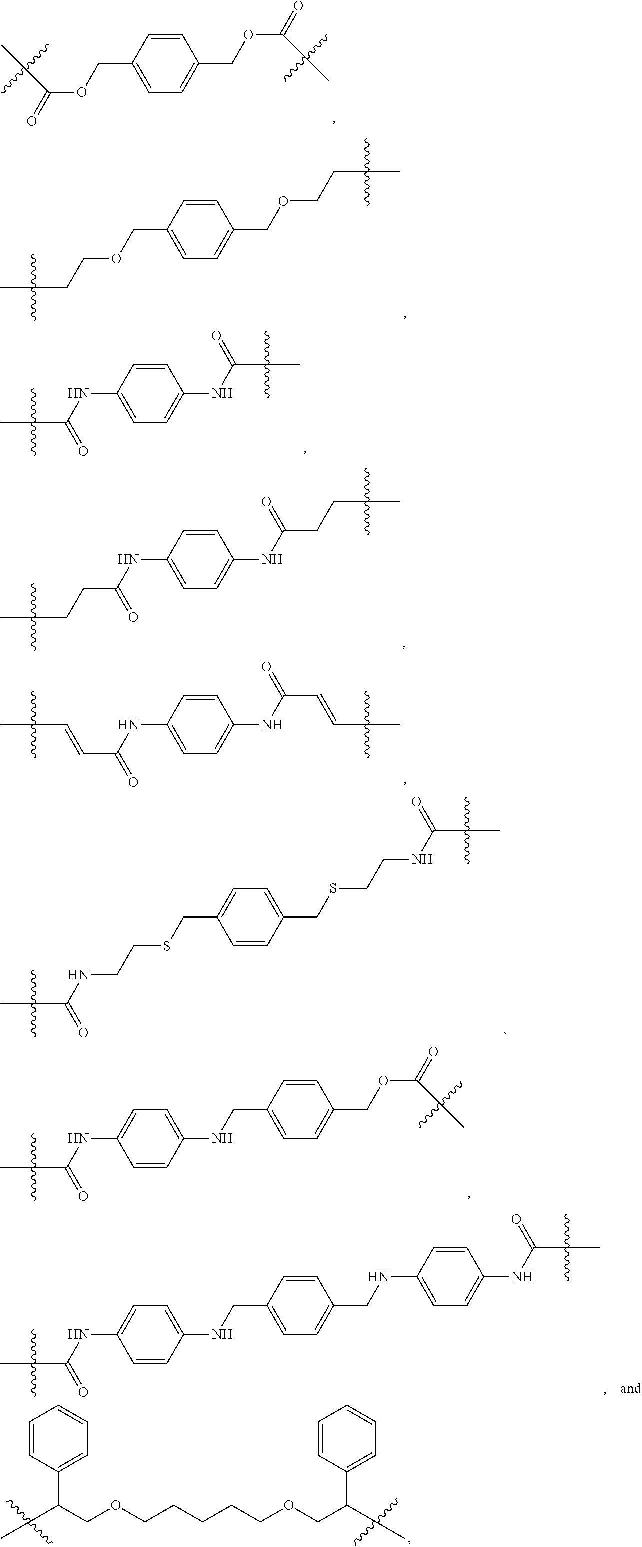

where

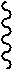

denotes the point of coupling with a graphene oxide sheet. Each of these crosslinkers can be optionally substituted.

In some embodiments, the chemical linker 130 can have one of the following structures:

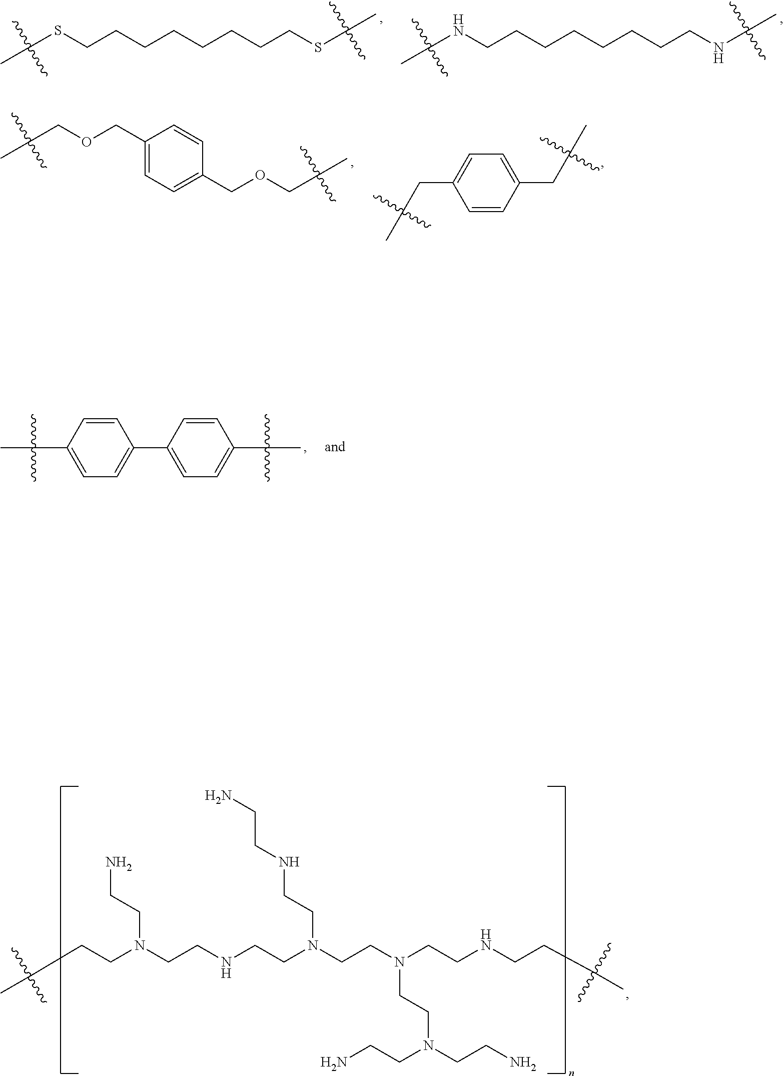

where: n is 1 to 5;

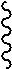

denotes the point of coupling to the chemical spacer 120.

Swelling of membranes can be problematic because it can adversely affect the structural integrity of the membrane, change the molecular weight cutoff, etc. Without being bound by any particular theory, it is believed that the interaction (e.g., van der Waals interactions) between the graphene oxide sheets 110 are relatively weak and certain solvents and/or solvents at certain temperatures enter into the region between the sheets and disrupt some of these interactions resulting in swelling and/or destabilization. The crosslinkers 140 may serve to stabilize the graphene oxide membrane 100 from destabilization in solvents and/or at elevated temperatures. In some embodiments, the crosslinker 140 may have a length and/or density that substantially reduces swelling of the graphene oxide membrane 100 in certain environments (e.g., solvents, elevated temperatures, etc.) and/or prevents destabilization of the graphene oxide membrane 100.

In some embodiments, the weight ratio of graphene oxide to crosslinker 140 in the finished membrane can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of graphene oxide to crosslinker 140 in the finished membrane can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

Some embodiments of the graphene oxide membrane 100 can be found in the disclosures of International Patent Application Number PCT/US2020/078051 entitled “Filtration Apparatus Containing Alkylated Graphene Oxide Membrane,” filed Oct. 13, 2022 (“the '051 application”), U.S. Pat. No. 11,097,227, titled, “Durable Graphene Oxide Membranes,” issued Aug. 24, 2021 (“the '227 patent”), and U.S. Pat. No. 11,123,694, titled, “Filtration Apparatus Containing Graphene Oxide Membrane,” issued Sep. 21, 2021 (“the '694 patent”), which are incorporated herein by reference.

FIG. 1A shows the filtration apparatus 1000 includes a functionalized support 200 on which the graphene oxide membrane 100 can be disposed. The functionalized support 200 can be and/or include a support and/or substrate material comprising covalently bound and/or grafted surface chemical functional groups which impart specific chemical and/or physical properties to the functionalized support 200 for its use as backing of the graphene oxide membrane 100. The functionalized support 200 can act as a protective layer that prevents damage of the graphene oxide membrane 100 and other components of the filtration apparatus 1000. For example, the functionalized support 200 can protect the graphene oxide membrane 100 from damage (e.g., formation of pinholes, punctures, cracks, or other mechanical stress-induce defects) resulting from the fabrication of spiral membranes, and/or the use of the filtration apparatus 1000 under harsh environment conditions (high pressure, highly alkaline conditions, extended periods of time, etc.). The functionalized support 200 can exhibit chemical and/or physical properties stemming from the surface chemical functional groups that improve the performance of the graphene oxide membrane 100 in a variety of applications. These surface chemical functional groups, which can also be referred to as “surface functional groups,” can be covalently bound and/or grafted to the functionalized support 200 by means of free radical co-polymerization reactions, as further described herein.

The surface functional groups of the functionalized support 200 can impart one or more chemical and/or physical properties and/or characteristics to the functionalized support 200 to facilitate the fabrication of the filtration apparatus 1000, and/or improve the performance (e.g., rejection rate, selectivity, molecular weight cutoff, thermal stability etc.) of the filtration apparatus 1000. For example, in some embodiments the functionalized support 200 can include surface functional groups that improve the thermal stability of the functionalized support 200, enabling the use of the filtration apparatus 1000 at high temperatures, as further disclosed herein. In some embodiments, the functionalized support 200 can include surface functional groups that impart hydrophobic or hydrophilic character to the functionalized support 200, such that the functionalized support 200 can adequately match the hydrophilicity/hydrophobicity of solutions containing graphene oxide and/or other chemical species employed in the fabrication of the graphene oxide membrane 100. In that way, the surface functional groups of the functionalized support 200 can facilitate the formation of a high-quality filtration apparatus 1000 with a graphene oxide membrane 100 free of defects (e.g., pinholes, flakes, cracks, rough surface spots, etc.). In some embodiments, the functionalized support 200 can include surface functional groups exhibiting and/or having a net charge (e.g., ionic species such as polyelectrolytes), which improve the rejection of charged species such as salts and other ionic and/or cationic species, as further described herein.

In some embodiments, the functionalized support 200 can include hydrophilic surface functional groups. These hydrophilic surface functional groups may be nonionic, anionic, or cationic. In some embodiments the surface functional groups can be disposed on the functionalized support 200 such that the surface functional groups collectively form a hydrophilic polyelectrolyte layer that facilitate adsorption and diffusion of water. In such embodiments, the polyelectrolyte layer can include hydrophilic surface functional groups such as poly (allyl amine), poly (allyl amine HCl), polyethylene glycol (PEG), hydroxypropyl methyl cellulose (HPMC), polyacrylamide, and/or polyacrylamide dopamine, poly (sodium styrene sulfonate), polyethyleneimine, and polycyclic carboxylic and/or sulfonic acids. These polyelectrolyte layer materials can exhibit structural diversity: formal charges, chemical moieties, aliphatic, and aromatic, as further described herein.

The functionalized support 200 can include and/or be made of a support and/or substrate material such as a non-woven fiber or polymeric membrane containing polyethersulfone (PES). The PES in the support and/or substrate material can be used to covalently bind and/or graft surface functional groups, as further described herein. In some embodiments, the functionalized support 200 can be and/or include a polymeric membrane made entirely of PES. In some embodiments, the functionalized support 200 can be and/or include a multilayer polymeric membrane including PES and other polymeric materials. For example, in some embodiments the functionalized support 200 can be and/or include a multilayer polymeric membrane including a PES layer, and one or more additional layers coupled to and/or disposed one side of the PES layer. In such embodiments, the one or more additional layers can include, for example, polypropylene (PP), polystyrene, polyethylene, polyethylene oxide, polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, or polyether ether ketone.

In some embodiments the functionalized support 200 can include two or more layers. For example, the functionalized support 200 can include a first layer and a second layer, the first layer can be made of and/or include PES and be disposed on the second layer, wherein the first layer and the second layer have different average pore sizes. In some embodiments, the graphene oxide membrane 100 is disposed on the first layer, and the first layer has a smaller average pore size than the second layer.

To improve the filtration apparatus 1000 durability under high pressure operation, e.g., about 500 psi to 1600 psi or greater, in some embodiments, the functionalized support 200 can have a Young's modulus of no more than about 1,200 Mpa, no more than about 1,000 Mpa, no more than about 800 Mpa, no more than about 700 Mpa, no more than about 600 Mpa, no more than about 500 Mpa, no more than about 400 Mpa, no more than about 300 Mpa, or no more than about 200 Mpa, inclusive of all values and ranges therebetween. In some embodiments, the functionalized support 200 can have a Young's modulus of at least about 200 Mpa, at least about 250 Mpa, at least about 300 Mpa, at least about 450 Mpa, at least about 550 Mpa, at least about 650, at least about 750 Mpa, at least about 850 Mpa, at least about 950 Mpa, or at least about 1200 Mpa, inclusive of all values and ranges therebetween.

In some embodiments, the functionalized support 200 can have a glass transition temperature of about 220° C., about 230° C., about 240° C., about 250° C., about 260° C. about 270° C. about 280° C., inclusive of all values and ranges therebetween.

As described above, the functionalized support 200 includes surface functional groups covalently bound and/or grafted to the functionalized support 200 via chemical modification. The surface functional groups can be bound and/or grafted to any interior and/or exterior surface of the functionalized support 200, which may include the interstitial surface of voids and pores within the functionalized support, and/or any external surface and/or an external side or layer of the functionalized support 200. Said in other words, the surface functional groups can be covalently bound and/or grafted to any portion of the total surface area of the functionalized support 200, with the total surface area of the functionalized support 200 being defined as the specific surface area (SSC) of the functionalized support 200 measured in m²/Kg via adsorption based methods such as the Brunauer-Emmet-Teller (N₂-BET), multiplied by the total mass of the functionalized support 200 in Kg. The surface functional groups can be covalently bound and/or grafted to a PES surface of the functionalized support 200 (e.g., a surface of the functionalized support 200 which contains and/or includes PES) by initiating free radical co-polymerization reactions with suitable monomers. Said in other words, the functionalized support 200 can be fabricated by exposing one or more monomers and a support and/or substrate material that includes PES to an activation procedure. The activation procedure consists of transferring energy to the support and/or substrate material, and more specifically to the PES included in the support and/or substrate material, to catalyze the formation of sulfonyl and/or aryl radicals, which in turn react with the one or more monomers via free radical co-polymerization reactions producing surface functional groups covalently bound and/or grafted to the support and/or substrate material. In some embodiments, the activation procedure includes exposing the PES and the one or more suitable monomers to an Ultraviolet (UV) light source to initiate free radical co-polymerization reactions (e.g., activation via UV-induced free radical co-polymerization). In some embodiments, the activation procedure includes exposing the PES and the one or more suitable monomers to a high-energy surface activation technique such as corona discharge, plasma, ozone, electron beam or the like to initiate free radical co-polymerization reactions (e.g., activation via high energy treatment induced free radical co-polymerization). In some embodiments, the activation procedure includes exposing the PES and the one or more suitable monomers to an activation temperature to initiate free radical co-polymerization reactions (e.g., activation via thermally induced free radical co-polymerization).

The monomers used to fabricate the functionalized support 200 can be any suitable species which can react via UV-induced, high-energy treatment induced, and/or thermally induced free radical co-polymerization reactions with the PES in the support and/or substrate material. For example, in some embodiments the surface functional groups can be covalently bound to a PES surface of the functionalized support 200 by UV-induced, high energy treatment induced, and/or thermally-induced co-polymerization of allyl monomers having the general structure:

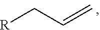

where R can be selected from —NH₂, —OH, —CH₂—COOH, —O—C₁-C₁₀, C₁-C₁₀ alkyl, C₁-C₁₀ alkenyl, or C₁-C₁₀ hydroxyalkyl (the C₁-C₁₀ species being either cyclic or acyclic), benzyl ether, phenyl ether, and/or allyloxy-1,2-propanediol.

In some embodiments, the surface functional groups can be covalently bound to a PES surface of the functionalized support 200 by UV-induced, high energy treatment induced, and/or thermally induced co-polymerization of vinyl monomers having the general structure:

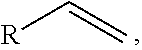

where R can be selected from —O—C₁-C₁₀, —C₀-C₁₀(O)—OH, —O—C₁-C₁₀—OH (the C₁-C₁₀ species being either cyclic or acyclic), vinyl triethoxysilane, pyridine (4-vynilpyridine), benzene, or phenol.

In some embodiments, the surface functional groups can be covalently bound to a PES surface of the functionalized support 200 by UV-induced, high-energy treatment induced, and/or thermally induced co-polymerization of cyclic olefin monomers having the general

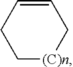

structure: where n is 4-8.

In some embodiments, the surface functional groups can be covalently bound to a PES surface of the functionalized support 200 by UV-induced, high-energy treatment induced, and/or thermally induced co-polymerization of cycloalkene and/or bicycloalkene monomers such as cyclopentane, cyclohexane, norbornenes and/or functionalized norbornene derivatives including alcohols, esters, carboxylic acids, ketones, alkyl chain functional groups, and/or endo-dicyclopentadiene.

In some embodiments, the surface functional groups can be covalently bound to a PES surface of the functionalized support 200 by UV-induced, high-energy treatment induced, and/or thermally induced co-polymerization of one or more monomers, including, but not limited to, allylamine, allyl alcohol, allyl methyl ether, ethyl vinyl ether, 4-vinylbenzoic acid, acrylic acid, ethylene glycol vinyl ether, norbornene, and/or phenyl vinyl ether.

In some embodiments, the surface functional groups can be covalently bound to a PES surface of the functionalized support 200 by UV-induced, high-energy treatment induced, and/or thermally induced co-polymerization of one or more monomers, including, but not limited to N-vinyl 2-pyrrolidone (NVP), 2-hydroxyethyl methacrylate (HEMA), 3-[[2-(Methacryloyloxy) ethyl] dimethylammonio] propane-1-sulfonate (DMAPS), and/or 4-penten-1-ol.

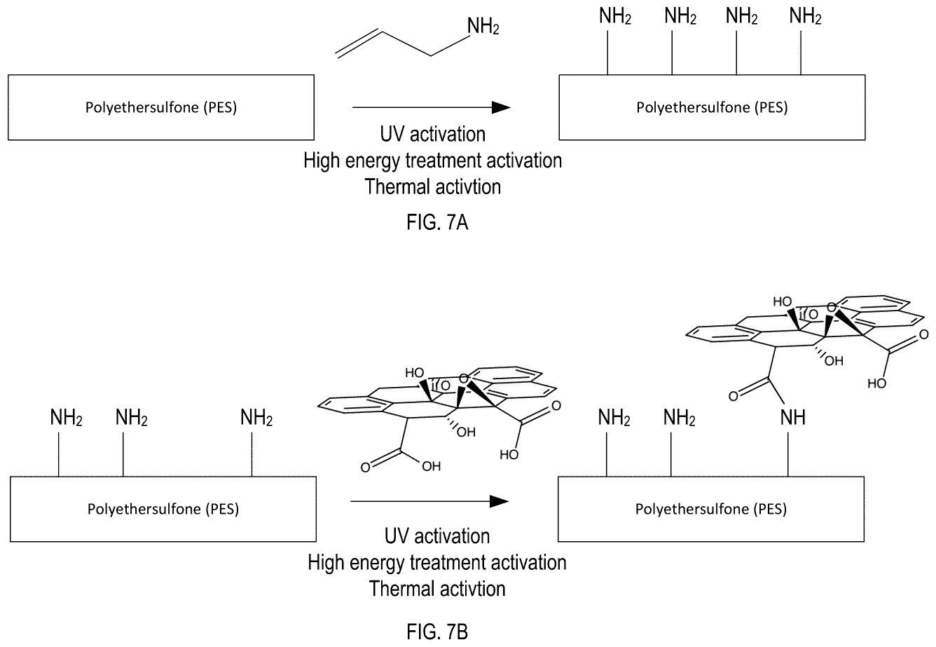

In some embodiments, the incorporation of surface functional groups on a PES surface of the functionalized support 200 via UV-induced, high-energy treatment induced, and/or thermally induced co-polymerization of selected monomers can cause cross-linking reactions between the graphene oxide membrane 100 and the functionalized support 200. For example, in some embodiments UV-induced, high-energy treatment induced, and/or thermally induced co-polymerization of amine-containing monomers such as allylamine with a PES surface of the functionalized support 200 can lead to, and/or result in cross-linking reactions between amine functional groups bound to the PES surface and pendant functional groups present in the graphene oxide sheets (e.g., carboxylic acid), producing amide links that covalently bind the graphene oxide sheets to the functionalized support 200, as illustrated in FIG. 7B. Alternatively, and/or additionally, in some embodiments UV-induced, high-energy treatment induced, and/or thermally induced co-polymerization of selected monomers with a PES surface of the functionalized support 200 can lead to, and/or result in cross-linking reactions between adjacent functional groups. That is, functional groups which are covalently bound a PES surface of the functionalized support 200 (via UV-induced, high-energy treatment induced, and/or thermally induced co-polymerization) and disposed on the PES surface adjacent to each other, can further react to produce crosslinked functional groups.

The content of nitrogen and carbon present on the surface of the functionalized support 200 provide an indication of the surface concentration and/or surface coverage of functional groups covalently bound to the functionalized support 200. The content of nitrogen and carbon present on the surface of the functionalized support 200 can be determined by X-Ray photoelectron Spectroscopy. In some embodiments, the atomic percent (at %) content of nitrogen present on the surface of the functionalized support 200 measured by X-Ray photoelectron Spectroscopy can be less than about 5.0 at %, less than about 4.5 at %, less than about 4.0 at %, less than about 3.5 at %, less than about 3.2 at %, less than about 3.0 at %, less than about 2.8 at %, less than about 2.6 at %, less than about 2.4 at %, less than about 2.2 at %, less than about 2.0 at %, inclusive of all values and ranges therebetween. In some embodiments, the atomic percent (at %) content of nitrogen present on the surface of the functionalized support 200 measured by X-Ray photoelectron Spectroscopy can be at least about 0.6 at %, at least about 1.1 at %, at least about 1.2 at %, at least about 1.3 at %, at least about 1.4 at %, at least about 1.5 at %, at least about 1.6 at %, at least about 1.8 at %, at least about 2.0 at %, inclusive of all values and ranges therebetween.

Combinations of the above referenced ranges for the at % content of nitrogen on the surface of the functionalized support 200 are also possible (e.g., at least about 0.6 at % to less than about 5.0 at %, or at least about 1.1 at % to less than about 3.2 at %).

In some embodiments, the atomic percent (at %) content of carbon present on the surface of the functionalized support 200 measured by X-Ray photoelectron Spectroscopy can be less than about 80%, less than about 78%, less than about 75%, inclusive of all values and ranges therebetween. In some embodiments, the at % content of carbon present on the surface of the functionalized support 200 measured by X-Ray photoelectron Spectroscopy can be at least about 50%, at least about 55%, or at least about 60%, inclusive of all values and ranges therebetween.

Combinations of the above referenced ranges for the at % content of carbon present on the surface of the functionalized support 200 are also possible (e.g., at least about 50% to less than about 80%, or at least about 60% to less than about 75%).

In some embodiments, graphene oxide membrane 100 and the functionalized support 200 can have a combined thickness of about 50 μm to about 1300 μm, about 100 μm to about 750 μm, about 200 μm to about 1000 μm, or about 200 μm to about 1200 μm, inclusive of all values and ranges therebetween.

In some embodiments, the functionalized support 200 can have a thickness of no more than about 1200 μm, no more than about 1000 μm, no more than about 800 μm, no more than about 600 μm, no more than about 400 μm, no more than about 200 μm, nor more than about 100 μm, or no more than about 45 μm, inclusive of all values and ranges therebetween. In some embodiments, the functionalized support 200 can have a thickness of at least about 75 μm, at least about 100 μm, or at least about 200 μm, inclusive of all values and ranges therebetween.

Combinations of the above referenced ranges for the thickness of the functionalized support 200 are also possible (e.g., a thickness of at least about 75 μm to no more than about 1200 μm, at least about 100 μm to no more than about 1000 μm).

The porosity of the functionalized support 200 can have an impact on the flux of the graphene oxide membrane 100. Specifically, a small average pore size of can improve the flux and/or rejection rate of the graphene oxide membrane 100. For example, in some embodiments the functionalized support 200 can have an average pore size of less than about 1 μm, less than about 800 nm, less than about 600 nm, less than about 400 nm, less than about 200 nm, or less than about 100 nm. In some embodiments, the functionalized support 200 can have an average pore size of at least about 100 nm, at least about 250 nm, at least about 500 nm, at least about 750 nm, at least about 1 μm, inclusive of all values and ranges therebetween.

In some embodiments, the functionalized support 200 (as well as any suitable support and/or substrate material) can have its porous structure modified by subjecting the functionalized support 200 to one or more processing steps. For example, in some embodiments the porous structure of the functionalized support 200 can be reduced and/or collapsed by exposing the functionalized support 200 to water (e.g., soaked the functionalized support 200 in water) for a period of time sufficient to allow water to penetrate and fill the pores present in the functionalized support 200. The functionalized support 200 can then be dried under ambient conditions (e.g., room temperature and a pressure of about 1 atm) for a similar period of time. In some instances, this period of time can be between about 6 hours and about 72 hours. Exposure of the functionalized support 200 to soaking water and subsequent drying under ambient conditions can cause the porous structure of the functionalized support 200 to be disrupted and/or collapsed, which can also be referred to as a “collapsed functionalized support.”

The roughness of the functionalized support 200 can have an impact on the flux of the graphene oxide membrane 100. Specifically, a smooth functionalized support 200 can improve the flux and/or rejection rate of the graphene oxide membrane 100 as compared to a rough functionalized support 200. Accordingly, in some embodiments, the functionalized support 200 can be smooth. For example, the functionalized support 200 can have a root mean squared surface roughness of less than about 3 μm, less than about 2.5 μm, less than about 2 μm, less than about 1.5 μm, or less than about 1 μm. In some embodiments, the functionalized support 200 can have a root mean squared surface roughness of at least about 1 μm, at least about 1.2 μm, at least about 1.4 μm, at least about 1.5 μm, inclusive of all values and ranges therebetween. In some embodiments, the surface roughness is measured by a Dektak 6M Contact Profilometer.

In some embodiments, the functionalized support 200 can comprise a hollow polymer tube. The hollow polymer tube can have a surface area greater than or equal to about 100 cm².

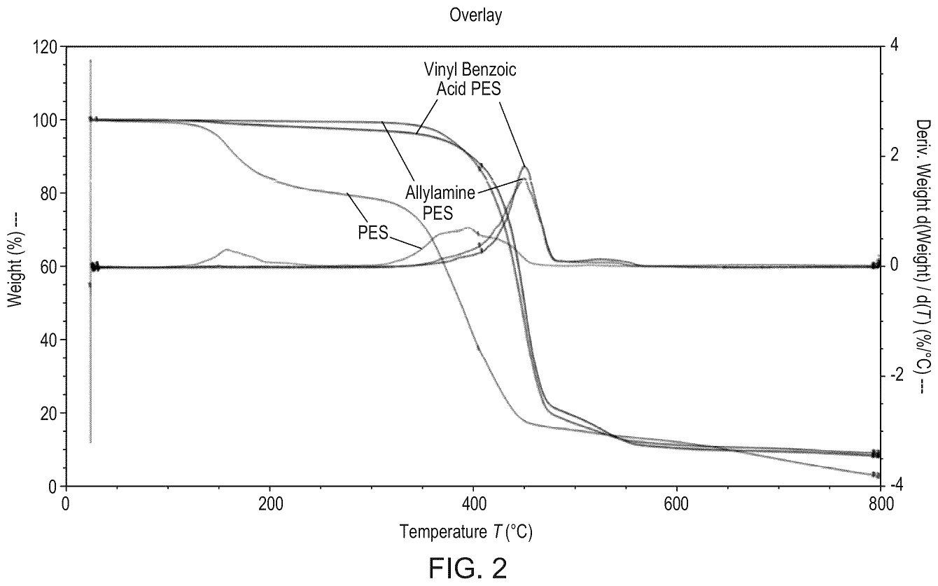

As described above, the functionalized support 200 can include surface functional groups that improve the thermal stability of the functionalized support. FIG. 2 shows thermogravimetric analyzer (TGA) curves illustrating the thermal stability of different support and/or substrate materials including: a PES support (e.g., a support made of and/or including a polymeric membrane comprising PES and no surface functional groups grafted to the PES), an allylamine PES functionalized support 200 (e.g., a functionalized support 200 made of and/or including a polymeric membrane comprising PES and allylamine surface functional groups grafted to the PES), and a vinyl benzoic acid PES functionalized support 200 (e.g., a functionalized support 200 made of and/or including a polymeric membrane comprising PES and vinyl benzoic acid surface functional groups grafted to PES). FIG. 2 shows the PES support exhibits a first onset temperature of about 150° C., and a second onset degradation temperature of about 375° C. The TGA curve of FIG. 2 further reveals that the PES support can undergo considerable thermal degradation and lose nearly 80% of its weight at temperatures above 400° C. Consequently, the PES support may not be best suited for applications that involve high temperatures and or exposure to high temperatures for extended periods of time. The TGA curves of FIG. 2 also show the allylamine PES functionalized support 200 and the vinyl benzoic acid PES functionalized support 200 exhibit onset degradation temperatures higher than 400° C. The presence of allylamine and/or vinyl benzoic acid surface functional groups grafted to PES improve the temperature stability of the functionalized support 200, resulting in negligible weight loss at temperatures below 400° C. Consequently, a PES functionalized support 200 including surface functional groups such as allylamine, vinyl benzoic acid, and/or other functional groups disclosed herein can improve the thermal stability of the filtration apparatus 100 and enable the use of the graphene oxide membrane 100 at high temperatures.

The performance of the filtration apparatus 1000 described herein can be characterized by the rejection rates for specific solute species. The rejection rates described herein were measured using solutions containing solute species at high concentrations (e.g., monovalent and/or divalent salts at 1 wt. % or higher), to reflect the conditions typically encountered in commercially relevant applications and/or processes (e.g., black liquor or seawater processing). It is worth noting that graphene oxide membrane performance measurements evaluated at low solute concentrations (e.g., salt concentration ≤0.5 wt. %), particularly in laboratory settings, can result in very high rejection rates (e.g., >90%) due to material absorption rather than permeance. Increasing the concentration of the solute species present in the solution leads to a sharp reduction of the measured rejection rate. For example, the rejection rate of graphene oxide membranes measured using an aqueous solution containing 0.584 wt. % NaCl (˜0.1 M) can be as high as 80%. Increasing the concentration of NaCl in the aqueous solution from 0.584 wt. % to 2.92 wt. % (˜0.5 M) can decrease the rejection rate to about 45%. The high rejection rates typically observed at low salt concentrations are attributed to electrostatic repulsion between negatively charged carboxylic acid groups present on the graphene oxide (e.g., at pH>4) and the salt anions in the solution. Repulsion is particularly enhanced for divalent anions. As the concentration of salt is increased, the charges on the membrane are shielded by the ions present in the salt in solution, which cause the electrostatic repulsion to decrease. Under those conditions, the permeance of the filtration apparatus has a dominant effect on the observed rejection rate.

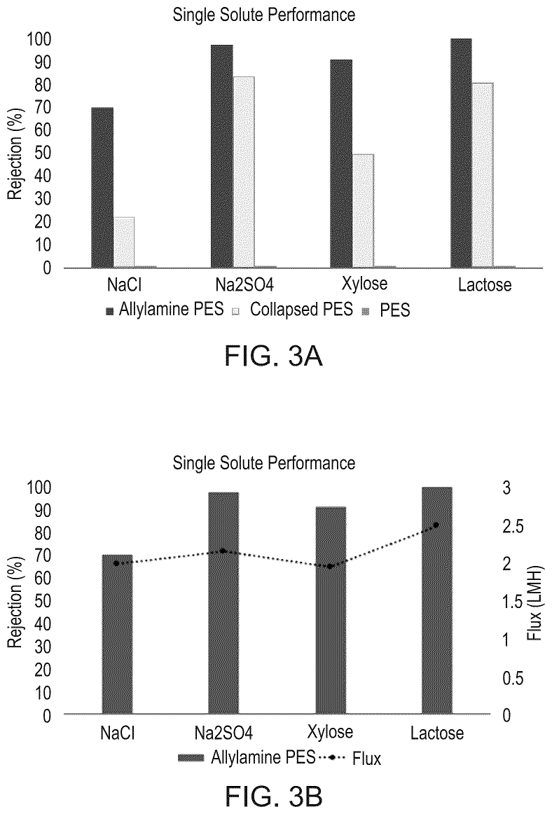

The filtration apparatus 1000 of the present disclosure can have rejection rates with tunable selectivity for various small molecules, monovalent/divalent salts and/or ions, and other species present at high concentrations (e.g., 1 wt. % or higher). More specifically, the selection of the functionalized support 200 can have a direct impact on the rejection rate and selectivity of the filtration apparatus 1000. FIG. 3A shows the performance of various supports for the filtration of solutions containing solute species of different net charge and molecular size. The supports in FIG. 3A include a PES support, a collapsed PES support, and an allylamine PES functionalized support 200 (e.g., a functionalized support 200 made of and/or including a polymeric membrane comprising PES and allylamine surface functional groups grafted to the PES). The rejection rates shown in FIG. 3A were measured using a dead-end filtration cell, flowing single solute aqueous solutions containing 1 wt. % (10,000 ppm) of a selected species such as Sodium Chloride (NaCl, 58 Da, −1 charge), Sodium Sulfate (Na₂SO₄, 142 Da, −2 charge), xylose (150 Da), or lactose (342 Da) at room temperature (e.g., 25° C.), and 250 psi, and determining the rejection rate for each solute species using both refractive index (RI) and a conductivity method, as further described herein.

FIG. 3A shows the PES support (e.g., a support made of and/or including a polymeric membrane comprising PES and no surface functional groups grafted to the PES) displays negligible rejection rates (e.g., rejections rates close to zero) for solute species having molecular size equal to or smaller than of 350 Da (<350 Da). Additional experiments (not shown) reveal the PES support can only shows a rejection rate of about 76% for a Dextran solute having a molecular weight of 6000 Da. The use of a PES support having a collapsed porous structure (e.g., Collapsed PES in FIG. 3A, a support in which the porous structure has been destroyed as described above) can increase the rejection rate of solute species with molecular size smaller than 350 Da. For example, the Collapsed PES support of FIG. 3A can achieve a rejection rate of about 80% for lactose (342 Da), 49% for xylose (150 Da), 83% for NaSO4 (142 Da), and 22% for NaCl (58 Da). Interestingly, use of a PES functionalized support 200 including surface functional groups can lead to significant increases in rejection rate. For example, as shown in FIG. 3A, the allylamine PES functionalized support 200 displays high rejections rates for solute species having molecular size smaller than 350 Da. More specifically, the allylamine PES functionalized support 200 shown in FIG. 3A can display rejection rates as high as about 100% for lactose (342 Da), 91% for xylose (150 Da), 98% for NaSO4 (142 Da), and 70% for NaCl (58 Da). Consequently, the use of a filtration apparatus 1000 including a PES functionalized support 200 having surface functional groups such as those described herein, can facilitate achieving high rejection rates, even with solute species of relatively small molecular size such as NaCl.

FIG. 3B shows the rejection rate (%) and water flux (in L/m² h, or LHM) for the allylamine PES functionalized support 200 shown in FIG. 3A measured using a dead-end filtration cell flowing single solute aqueous solutions containing 1 wt. % (10,000 ppm) of NaCl, Na₂SO₄, xylose, or lactose at room temperature (e.g., 25° C.), and 250 psi. As described above, the allylamine PES functionalized support 200 displays high rejection rates in the 70-100% range for all solute species tested having molecular size smaller than 350 Da, with mono or divalent net charge. Furthermore, the allylamine PES functionalized support 200 can exhibit low water fluxes in the range of 1.5 to 2.5 LMH. These low water fluxes are a striking contrast to the water fluxes typically reported in the prior art for PES functionalized supports, which can be about 20 to 30 times larger (e.g., water fluxes of about 55 LMH). FIG. 3B also shows the allylamine PES functionalized support 200 can retain nearly all sodium sulfate (Na₂SO₄), indicating that the allylamine PES functionalized support 200 has a low molecular weight cutoff (MWCO) of about 142 Da. (determined at a 90% rejection rate). It is important to note that the MWCO exhibited by the functionalized support 200 described herein, is significantly smaller than the MWCO exhibited by conventional functionalized supports, which can be about 500 times larger (e.g., about 80 kDa). The low MWCO of the functionalized support 200 described herein enable the use of the filtration apparatus 1000 in nanofiltration applications involving separation of small molecular size species, as well as applications in which high chemical stability and high monovalent and divalent ion rejection are required, such as acid concentration, sucrose concentration, and/or homogeneous catalyst concentration and/or purification.

It is important to note that incorporation of surface functional groups on the functionalized support 200 can significantly alter the MWCO displayed by the functionalized support 200. For example, in some embodiments a PES support (e.g., a support 200 made of and/or including a polymeric membrane comprising PES and no surface functional groups grafted to the PES) can exhibit a MWCO of about 10,000 Da. In contrast, a PES functionalized support 200 including a polymeric membrane comprising PES and surface functional groups such as those described herein grafted to the PES can exhibit a significantly reduced MWCO. For example, in some embodiments, the molecular weight cutoff of a functionalized support 200 comprising functional groups such as those described herein is about 140 Da. In some embodiments, the molecular weight cutoff for the functionalized support 200 comprising functional groups such as those described herein is about 150 Da. In some embodiments, the molecular weight cutoff for the functionalized support 200 comprising functional groups such as those described herein is about 200 Da. In some embodiments, the molecular weight cutoff for the functionalized support 200 comprising functional groups such as those described herein is about 250 Da. In some embodiments, the molecular weight cutoff for the functionalized support 200 comprising functional groups such as those described herein is about 300 Da. In some embodiments, the molecular weight cutoff for the functionalized support 200 comprising functional groups such as those described herein is about 350 Da.

In some embodiments, the functionalized support 200 can have a flux of at least about 0.10 LMH, at least about 0.2 LMH, at least about 0.4 LMH, at least about 0.8 LMH, at least about 1.0 LMH, at least about 1.5 LMH, at least about 2.0 LMH, at least about 2.5 LMH, at least about 3.0 LMH, at least about 4.0 LMH, at least about 5.0 LMH, at least about 6.0 LMH, at least about 7.0 LMH, or at least about 8.0 LMH, inclusive of all values and ranges therebetween, measured with a 1 wt. % (10,000 ppm) NaCl solution at room temperature (e.g., 25° C.) and 250 psi.

In some embodiments, the functionalized support 200 can have a flux of no more than about 8.0 LMH, no more than about 4.5 LMH, no more than about 2.5 LMH, no more than about 1.0 LMH, no more than about 0.5 LMH, no more than about 0.10 LMH, inclusive of all values and ranges therebetween, measured with a 1 wt. % (10,000 ppm) NaCl solution at room temperature (e.g., 25° C.) and 250 psi.

Combinations of the above-referenced ranges for the flux are also possible (e.g., at least about 0.10 LMH and no more than about 6.0 LMH, or at least about 2.5 LMH and no more than about 7.5 LMH).

In some embodiments, the functionalized support 200 can have a flux of at least about 1.5 LHM, at least about 2.0 LHM, at least about 3.0 LHM, at least about 4.0 LHM, at least about 5.0 LHM, at least about 8.0 LHM, at least about 10.0 LHM, at least about 12 LHM, at least about 14 LHM, at least about 16 LHM, at least about 18 LHM, at least about 20 LHM, at least about 22 LHM, at least about 24 LHM, or at least about 26 LHM, inclusive of all values and ranges therebetween, measured with a Weak Black Liquor solution (WBL, 3.9% total dissolved solids, 23.7 mS conductivity) at room temperature (e.g., 25° C.) and 250 psi.

In some embodiments, the functionalized support 200 can have a flux of no more than about 26 LMH, no more than about 24 LMH, no more than about 18 LMH, no more than about 14 LMH, no more than about 26 LMH, no more than about 26 LMH, no more than about 26 LMH, no more than about 10 LMH, no more than about 6 LMH no more than about 4 LMH no more than about 3 LMH no more than about 2 LMH or no more than about 1.5 LMH inclusive of all values and ranges therebetween, measured with a Weak Black Liquor solution (WBL, 3.9% total dissolved solids, 23.7 mS conductivity) at room temperature (e.g., 25° C.) and 250 psi.

Combinations of the above-referenced ranges for the flux are also possible (e.g., at least about 1.5 LMH and no more than about 24 LMH, or at least about 5 LMH and no more than about 18 LMH).

In some embodiments, the flux of the functionalized support 200 and/or the filtration apparatus 100 is measured at 200 psi to 1200 psi, such as about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, about 650 psi, about 675 psi, about 700 psi, about 725 psi, about 750 psi, about 775 psi, about 800 psi, about 825 psi, about 850 psi, about 875 psi, about 900 psi, about 925 psi, about 950 psi, about 975 psi, about 1000 psi, about 1100 psi, or about 1200 psi.

In some embodiments, the functionalized support 200 can have a NaCl rejection rate of at least 20%, at least 30%, at least %, at least 40%, at least 50%, at least 60%, at least 65%, or at least 70%, measured with a 1 wt. % (10,000 ppm) NaCl solution at room temperature (e.g., 25° C.) and 250 psi.

In some embodiments, the functionalized support 200 can have a NaCl rejection rate of 20% to 70% with a 1 wt. % (10,000 ppm) NaCl solution. In some embodiments, the functionalized support 200 can have a NaCl rejection rate of 30% to 70% with a 1 wt. % (10,000 ppm) NaCl solution. In some embodiments, the functionalized support 200 can have a NaCl rejection rate of 40% to 70% with a 1 wt. % (10,000 ppm) NaCl solution. In some embodiments, the functionalized support 200 can have a NaCl rejection rate of 50% to 70% with a 1 wt. % (10,000 ppm) NaCl solution. In some embodiments, the functionalized support 200 can have a NaCl rejection rate of 60% to 70% with a 1 wt. % (10,000 ppm) NaCl solution. In some embodiments, the functionalized support 200 can have a NaCl rejection rate of 65% to 70% with a 1 wt. % (10,000 ppm) NaCl solution.

The procedure for characterizing rejection and permeability of a functionalized support 200 is shown below: (1) cut a 47 to 50 mm disc from the functionalized support 200 using a razor blade or laser cuter; (2) load the disc onto a porous stainless steel frit, which is then mounted into a Sterlitech HP4750 filtration cell; (3) add 60 to 100 mL of 1 wt. % (10,000 ppm) single solute aqueous solution; (4) place the setup on a stir plate at approximately 750 rpm; (4) close the feed chamber and pressurize it to 50 to 1000 psi. Under this procedure, at least 15 mL of permeate is collected across three samples to ensure that the performance measurement was steady.

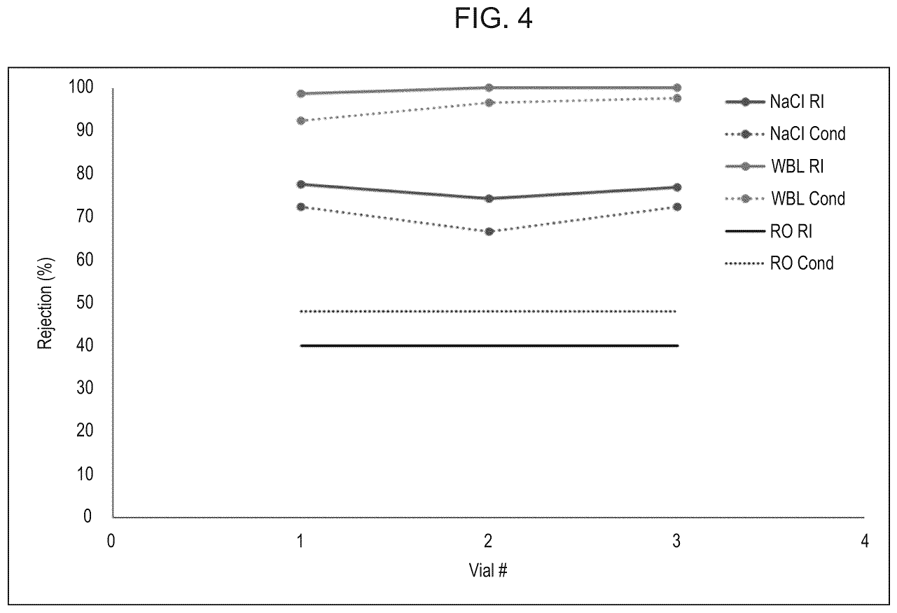

FIG. 4 shows the performance of an allylamine PES functionalized support 200 measured at room temperature (e.g., 25° C.) and 250 psi with two different solutions including: a diluted WBL solution (3.9% total dissolved solids, 23.7 mS conductivity), and a 1 wt. % (10,000 ppm) NaCl solution. Each experiment was performed three separate times (e.g., vials #1, 2, and 3). It is worth noting that the WBL solution was diluted in order to overcome the minimum osmotic pressure. FIG. 4 shows the allylamine PES functionalized support 200 exhibits a near perfect retention of WBL, with a high total solids rejection rate of about 92-99% measured by conductivity (Cond) and refractive index (RI, the rejection rate being calculated as

$$rejection rate = \frac{1 - Permeate RI}{Feed RI} \times 100 ) .$$

FIG. 4 shows the allylamine PES functionalized support 200 also exhibits a high rejection rate of about 70% to 80% for NaCl. For comparison purposes, FIG. 4 also shows the rejection rate of a commercially available Reverse Osmosis (RO) membrane (FilmTec™ SW30, Dupont), which exhibits a rejection rate of only about 40 to 50%.

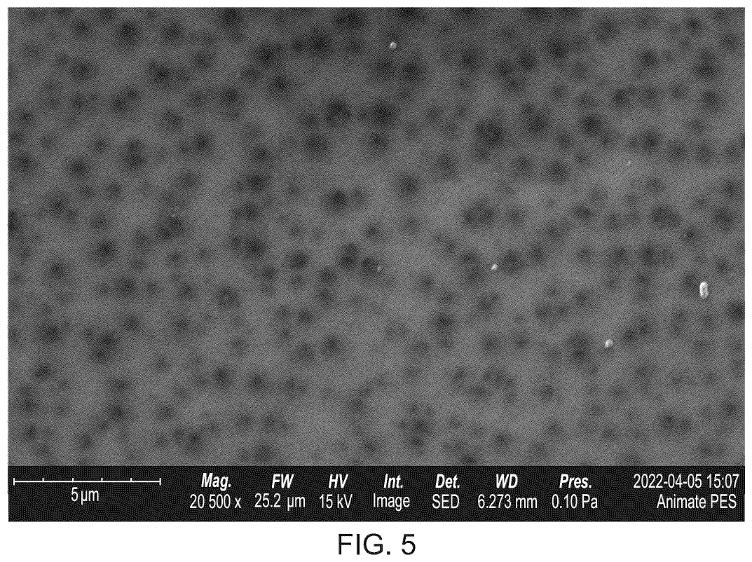

FIG. 5 shows a Scanning Electron Microscope (SEM) micrograph displaying the morphology of the functionalized support 200. FIG. 4 shows the porous structure of the functionalized support 200, which includes pores as large as ˜500 nm. As described above, the porosity of the functionalized support 200 can have a significant impact on its performance. In some embodiments, the functionalized support 200 can include pores of no more than about 500 nm.

The concentration of nitrogen and carbon present on a PES surface of the functionalized support 200 can provide an indication of the coverage and/or spatial distribution of surface functional groups covalently bound and/or disposed on the functionalized support 200. In some embodiments, the concentration of nitrogen and carbon on the functionalized support 200 can be determined by Energy Dispersive Spectroscopy (EDS). For example, in some instances the content of nitrogen and carbon present on the surface of the functionalized support 200 can be determined via electron microscopy by preparing one or more suitable samples and analyzing the surface of the samples with an SEM equipped with an EDS system. In such instances, the content of nitrogen and carbon present on the surface of the functionalized support 200, as well as the local distribution of surface functional groups (e.g., the formation of local surface clusters, monolayers, and/or any other local surface distribution of functional groups) can be determined with the SEM-EDS. In some embodiments, the atomic percent (at %) content of nitrogen present on the surface of the functionalized support 200 measured by EDS can be less than about 5.0 at %, less than about 4.5 at %, less than about 4.0 at %, less than about 3.5 at %, less than about 3.2 at %, less than about 3.0 at %, less than about 2.8 at %, less than about 2.6 at %, less than about 2.4 at %, less than about 2.2 at %, less than about 2.0 at %, inclusive of all values and ranges therebetween. In some embodiments, the atomic percent (at %) content of nitrogen present on the surface of the functionalized support 200 measured by EDS can be at least about 0.6 at %, at least about 1.1 at %, at least about 1.2 at %, at least about 1.3 at %, at least about 1.4 at %, at least about 1.5 at %, at least about 1.6 at %, at least about 1.8 at %, at least about 2.0 at %, inclusive of all values and ranges therebetween.

In some embodiments, the atomic percent (at %) content of carbon present on the surface of the functionalized support 200 measured by EDS can be less than about 80%, less than about 78%, less than about 75%, inclusive of all values and ranges therebetween. In some embodiments, the at % content of carbon present on the surface of the functionalized support 200 measured by EDS can be at least about 50%, at least about 55%, or at least about 60%, inclusive of all values and ranges therebetween

In some embodiments, the incorporation of surface functional groups on a PES surface of the functionalized support 200 via UV-induced, high-energy treatment induced, and/or thermally induced co-polymerization of selected monomers having an acid and/or basic chemical functionality (e.g., addition of acidic or basic surface species such as amines and/or carboxylic acids covalently bound to the PES surface of the functionalized support 200) can increase the magnitude of the zeta potential on the PES surface. The increased zeta potential can favor and/or promote better Coulombic stabilization of pendant groups on the graphene oxide sheets of the graphene oxide membrane 100, which may result in improved adhesion and/or a more intimate contact between the graphene oxide membrane 100 and the functionalized support 200. In some embodiments, the functionalized support 200 can have a magnitude of zeta potential at a pH of about 7 of less than or equal to about 30 mV, about 25 mV, about 20 mV, about 15 mV, about 10 mV, about 9 mV, about 8 mV, about 7 mV, about 6 mV, or about 5 mV, inclusive of all values and ranges therebetween.

### Manufacture of the Functionalized Support and Filtration Apparatus

The fabrication of the graphene oxide membrane 100 includes dispersing graphene oxide sheets in a solvent to produce a stable dispersion. In some embodiments, the solvent can be water. In some embodiments, the solvent can be an organic solvent. The dispersion may exhibit certain physical and chemical characteristics in order to produce continuous and uniform coatings substantially free of structural defects such as pinholes. For example, the hydrophilicity of the dispersion should be adequately matched to the functionalized support 200 to ensure wetting of the support surface. This can be tested by contact angle measurements.

The stability of the dispersion can be inferred from the pH of the dispersion. For example, dispersions that exhibit acidic pH values (e.g., pH<5) can develop visible aggregates. Fabricating coatings with such dispersions lead to poor coverage, coating non-uniformity, and poor membrane performance. In contrast, dispersions that have basic pH are stable. Moreover, addition of basic additives to the dispersion can increase the magnitude of the zeta potential on the graphene oxide sheets, which in turn results in greater Coulombic stabilization.

The stability of the dispersion can be indirectly observed through UV-Vis spectroscopy measurements, owing to the absorption band at around 300 nm, attributed to n-to-p* transitions. At longer wavelengths (>500 nm) the graphene oxide sheets absorb very weakly, and consequently, any signal in this region can be attributed to scattering, rather than absorption, due to the formation of aggregates. The ratio of UV-Vis signal at 300 nm (due to absorption) and that observed at 600 nm (due to aggregate scattering) can be used to characterize the dispersion in the solution. Generally, the higher this ratio is, the better the graphene oxide sheets 110 are dispersed.

In some embodiments, the ratio of UV-Vis signal at 300 nm and that observed at 600 nm can be less than about 4.4, less than about 4.2, less than about 4.0, less than about 3.8, less than about 3.6, less than about 3.4, less than about 3.2, or less than about 3.0, inclusive of all values and ranges therebetween. In some embodiments, the ratio of UV-Vis signal at 300 nm and that observed at 600 nm can be at least about 3.0, at least about 3.1, at least about 3.2, at least about 3.3, or at least about 3.4, inclusive of all values and ranges therebetween.

Combinations of the above referenced ranges for the ratio are also possible (e.g., a ratio of at least about 3.0 to less than about 4.4, at least about 3.2 to less than about 4.0).

In some embodiments, the dispersion can further include viscosity modifiers and/or surfactants. In some embodiments, the viscosity modifier is hydroxypropyl methyl cellulose (HPMC). For example, the dispersion can include 0.01 wt. % viscosity modifier. In some embodiments, the surfactant is sodium dodecyl sulfide (SDS). For example, the dispersion can include about 0.15 wt % surfactant.

In some embodiments, the viscosity of the dispersion can be no more than about 1500 cP at a shear rate of around 0.08 Hz, no more than about 2000 cP at a shear rate of around 0.08 Hz, no more than about 2500 cP at a shear rate of around 0.08 Hz, no more than about 3000 cP at a shear rate of around 0.08 Hz, no more than about 3000 cP at a shear rate of around 0.08 Hz, no more than about 3500 cP at a shear rate of around 0.08 Hz, no more than about 4000 cP at a shear rate of around 0.08 Hz, no more than about 5000 cP at a shear rate of around 0.08 Hz, no more than about 6000 cP at a shear rate of around 0.08 Hz, or no more than about 8000 cP at a shear rate of around 0.08 Hz.

Combinations of the above referenced ranges for the viscosity of the dispersion are also possible (e.g., a viscosity of at least about 2000 cP and to no more than about 6000 cP at a shear rate of around 0.08 Hz, at least about 2500 cP to no more than about 5800 cP at a shear rate of around 0.08 Hz).

To produce dispersions that can coat well onto the functionalized support 200, the order of addition of reagents can be important. For example, prior to deposition, dispersions that undergo carbodiimide coupling conditions require adjustment of the pH to be greater than 8.0 prior to the addition of 1-Ethyl-3-(3-dimethylaminopropyl) carbodiimide (EDC) and N-hydroxysuccinimide (NHS).

Prior to the reaction with a chemical spacer precursor, the graphene oxide sheets 110 can be functionalized with one or more desirable chemical groups. For example, the graphene oxide sheets can be functionalized with amines. See Navaee, A. & Salimi, A, “Efficient amine functionalization of graphene oxide through the Bucherer reaction: an extraordinary metal-free electrocatalyst for the oxygen reduction reaction,” RSC Adv. 5, 59874-59880 (2015), the contents of which are incorporated by reference.

The graphene oxide sheets can also be functionalized with carboxylic groups. See Sydlik, S. A. & Swager, T. M., “Functional Graphenic Materials Via a Johnson-Claisen Rearrangement,” Adv. Funct. Mater. 23, 1873-1882 (2012); Collins, W. R., et al., “Rearrangement of Graphite Oxide: A Route to Covalently Functionalized Graphenes,” Angew. Chem., Int. Ed. 50, 8848-8852 (2011), the contents of each of which are incorporated by reference.

In some embodiments, the graphene oxide sheets can be functionalized with hydroxyl groups. For example, a graphene oxide sheet can react with an epoxide so that the graphene oxide sheet is functionalized with hydroxyl groups. Examples of epoxides include, but are not limited to, 1-2-epoxypropane, styrene oxide, ethylene oxide, epichlorohydrine, 1,2-epoxybutane, bisphenol, A diglycidyl ether, 1, 3-butadiene diepoxide and 1,2,7,8-diepoxyoctane.

Once the graphene oxide sheets have the desired chemical groups, they can be placed in contact with the chemical spacer precursor to initiate a reaction between the graphene oxide sheets and the chemical spacer precursor. The reaction conditions can vary, depending on the chemical spacer 120 used. As compared to existing processes, some embodiments of the process of the present disclosure can be performed under ambient environments (i.e., in the presence of oxygen and humidity).

In some embodiments, the graphene oxide sheets can be optionally coupled to an adjacent graphene oxide sheet via a chemical linker. In some embodiments molecules useful for initiating crosslinking between graphene oxide sheets can include, but are not restricted to, ester groups, sulfonated esters, ether groups, amines, carboxyl groups, carboxylic acids, carbonyl groups, amides, halides, thiols, alkanes, fluoroalkanes, alkyl groups, methyl groups, ethyl groups, propyl groups, butyl groups, pentyl groups, heptyl groups, octyl groups, nonyl groups, decyl groups, isopropyl, cyclopropyl, isobutyl, t-butyl, cyclobutyl, cyclohexyl, chloromethyl, bromoethyl, trifluoromethyl, methylamine, dimethylamine, ethylamine, diethylamine, methylethylamine, iso-propylamine, piperidine, trimethylamine, propylamine, hydroxy groups, hydroxyl groups, thio groups, 1,3,5-benzenetricarbonyl trichloride, aromatic dichlorides, aromatic trichlorides, terephthaloyl chloride, adipoyl chloride, propanediol, pentanediol, hexanediol, heptanediol, naphthyl, biphenyl, benzyl, hexyldiamine, 1,6-diiodohexane, 1,6-dibromohexane, 1,6-dichlorohexane, α,α′-dichloro-p-xylene, α,α′-diiodo-p-xylene, α,α′-dibromo-p-xylene, dichloromethylnapthalene, trichloromethylbenzene, dichloromethylbiphenyl, dibromomethylnapthalene, tribromomethylbenzene, dibromomethylbiphenyl, diiodomethylnapthalene, triiodomethylbenzene, diiodomethylbiphenyl, any other suitable crosslinking moieties, or combinations thereof.

In some embodiments, crosslinking moieties can be coupled to at least one graphene oxide sheet through esterification under appropriate reaction conditions.

In some embodiments, crosslinking moieties can be coupled to at least one graphene oxide sheet through amidation under appropriate reaction conditions.

In some, the crosslinking moiety can be coupled to at least one graphene oxide sheet through etherification under appropriate reaction conditions.

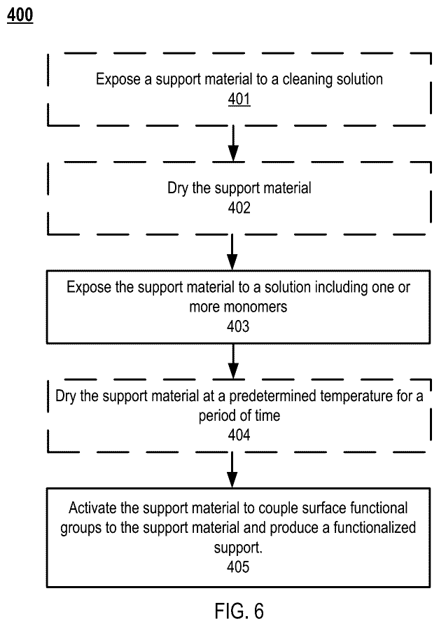

FIG. 6 shows a flow chart of an example method 400 for preparing a functionalized support, according to an embodiment. The method 400 can be used to prepare and/or fabricate a functionalized support such as the functionalized support 200 described above. The method 400 optionally includes at step 401, exposing a support and/or substrate material to a cleaning solution. The support and/or substrate material can be any suitable material which can be used to fabricate a functionalized support 200 by covalently binding and/or grafting surface functional groups. In some embodiments, the support and/or substrate material can include a polymeric membrane made entirely of PES. In some embodiments, the support and/or substrate material can include a multilayer polymeric membrane including PES and other polymeric materials. For example, in some embodiments the support and/or substrate material can be a multilayer polymeric membrane including a PES layer, and one or more additional layers coupled to and/or disposed one side of the PES layer. In such embodiments, the one or more additional layers can include, for example, polypropylene (PP), polystyrene, polyethylene, polyethylene oxide, polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, or polyether ether ketone.

The cleaning solution can be any suitable mixture that can be used to remove chemical reagents, additives, and/or contaminants present in the support and/or substrate material. In some instances, a support and/or substrate material may include chemical reagents and/or additives which may have been added during the support and/or substrate material initial fabrication. For example, in some instances the support and/or substrate material may include fire-retardant additives incorporated to the support and/or substrate material to enable its use in, for example, high temperature applications. In some instances, the support and/or substrate material may include binders, plasticizers, surfactants, or any suitable additive incorporated to the support and/or substrate material to facilitate the support and/or substrate material processability. In some instances, the support and/or substrate material may include contaminants such as sand, dust, and/or particulate matter which may be introduced during storage and/or transport of the support and/or substrate material. These additives and/or contaminants are species which can interfere with the fabrication of a functionalized support according to the method 400, and thus its presence on the support and/or substrate material may need to be reduced and/or eliminated. In some embodiments, the cleaning solution can be water. In some embodiments, the cleaning solution can be and/or include one or more organic solvent including, but not limited to, acetone, benzene, butanol, chloroform, diethyl ether, ethanol, hexane, and/or toluene. In some embodiments, the cleaning solution can be a mixture comprising water, and one or more component(s) added to facilitate the removal of chemical reagents, additives, and/or contaminants present in the support and/or substrate material. For example, in some embodiments the cleaning solution may be a mixture comprising water and a surfactant added to the cleaning solution to reduce the surface tension of water and facilitate diffusion of water in the support and/or substrate material to solubilize the chemical reagents, additives, and/or contaminants. In some embodiments, the exposure of the support and/or substrate material to the cleaning solution at step 401 can be implemented by submerging, soaking, and/or dipping the support and/or substrate material in a container filled with the cleaning solution. In some embodiments, step 401 can be implemented in a roll-to-roll process. In the roll-to-roll process, the support and/or substrate material can be conveyed along a roll-based processing line that includes one or more stations and/or modules such as a dispensing station/module, a heat treatment station/module, and/or a packaging station/module. Step 401 of the method 400 can be implemented in the roll-to-roll process by disposing the support and/or substrate material in a roll-to-roll coating device line which contains at least one dispensing module. The support and/or substrate material can be directed to the dispensing module where the cleaning solution can be dispensed using nozzles, sprinklers, doctor blades, pneumatic syringes, plungers, or the like, included in the dispensing module.

In some embodiments, the support and/or substrate material can be exposed to a cleaning solution for a period of time sufficient to remove the chemical reagents, additives, and/or contaminants present on the support and/or substrate material, or at least reduce their concentration. For example, in some embodiments the support and/or substrate material can be exposed to a cleaning solution for a period of time of at least about 2 hours, at least about 4 hours, at least about 6 hours, at least about 8 hours, at least about 12 hours, at least about 16 hours, at least about 20 hours, at least about 24 hours, at least about 30 hours, at least about 36 hours, at least about 40 hours, or at least about 48 hours, inclusive of all values and ranges therebetween.

The method 400 optionally includes at step 402, drying the support and/or substrate material. The support and/or substrate material may include moisture, solvents, and/or the cleaning solution incorporated to the support and/or substrate material during its initial fabrication, storage, transport, and/or during the step 401 described above. In some embodiments, the support and/or substrate material may be dried under ambient conditions (e.g., room temperature and a pressure of about 1 atm). In some embodiments, the support and/or substrate material may be dried at a drying temperature selected in consideration of the boiling point of any solvent and/or cleaning solution present in the support and/or substrate material. For example, in some embodiments the support and/or substrate material may be dried at a temperature of at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 110° C., at least about 120° C., at least about 130° C., or at least about 140° C., inclusive of all values and ranges therebetween. In some embodiments the support and/or substrate material may be dried at a temperature of no more than about 140° C., no more than about 130° C., no more than about 120° C., no more than about 100° C., no more than about 90° C., no more than about 80° C., no more than about 70° C., no more than about 60° C., no more than about 50° C., no more than about 40° C., no more than about 35° C., inclusive of all values and ranges therebetween. Combinations of the above referenced ranges for temperature for drying the support and/or substrate material are also possible (e.g., at least about 110° C. to less than about 120° C., or at least about 38° C. to less than about 55° C.). In some embodiments, the support and/or substrate material can be dried at the drying temperature in a vacuum oven. In some embodiments, the support and/or substrate material may be dried for a selected period of time (e.g., a drying time). For example, in some embodiments the support and/or substrate material may be dried for a drying time of at least about 2 hours, at least about 6 hours, at least about 12 hours, at least about 24 hours, at least about 36 hours, or at least about 48 hours, inclusive of all values and ranges therebetween. The drying of the support and/or substrate material at step 402 can be implemented, for example, by allowing the support and/or substrate material to remain under ambient conditions for the period of time. In some embodiments, the drying of the support and/or substrate material at step 402 can be implemented in a roll-to-roll process. In such embodiments, the support and/or substrate material can be disposed in a roll-to-roll coating device line which contains at least one heat treatment module. The support and/or substrate material can be directed to the heat treatment module where the support and/or substrate material can be dried by increasing the temperature using a furnace and/or oven included in the heat treatment module.

At step 403, the method 400 includes exposing the support and/or substrate material to a solution including one or more monomers. As described above, a functionalized support can be fabricated by covalently binding and/or grafting (e.g., coupling) surface functional groups to the support and/or substrate material. More specifically, the surface functional groups can be coupled to the support and/or substrate material by initiating free radical co-polymerization reactions with the one or more monomers. To initiate such reactions, the one or more monomers need to be disposed on the support and/or substrate material. In some embodiments the support and/or substrate material can be exposed to the solution containing the one or more monomers by immersing and/or wetting the support and/or substrate material in a container filled with the one or more monomers. In some embodiments, step 403 can be implemented in a roll-to-roll process. In such embodiments, the support and/or substrate material can be disposed in a roll-to-roll coating device line which contains at least one dispensing module. The support and/or substrate material can be directed to the dispensing module where the one or more monomers can be dispensed using nozzles, sprinklers, doctor blades, pneumatic syringes, plungers, slot die, gravure or the like, included in the dispensing station and/or module.

In some embodiments, the solution including the one or more monomers, which can also be referred to as a “monomer solution” can comprise any of the monomers disclosed above. For example, in some embodiments the monomer solution can include allyl monomers having the general structure:

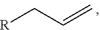

where R can be selected from —NH₂, —OH, —CH₂—COOH, —O—C₁-C₁₀, C₁-C₁₀ alkyl, C₁-C₁₀ alkenyl, or C₁-C₁₀ hydroxyalkyl (the C₁-C₁₀ species being either cyclic or acyclic), benzyl ether, phenyl ether, and/or allyloxy-1,2-propanediol. In some embodiments, the monomer solution can include vinyl monomers having the general structure:

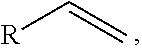

where R can be selected from —O—C₁-C₁₀, —C₀-C₁₀(O)—OH, —O—C₁-C₁₀—OH (the C₁-C₁₀ species being either cyclic or acyclic), vinyl triethoxysilane, pyridine (4-vynilpyridine), benzene, or phenol. In some embodiments, the monomer solution can include cycloalkene and/or bicycloalkene monomers such as cyclopentane, cyclohexane, norbornenes and/or functionalized norbornene derivatives including alcohols, esters, carboxylic acids, ketones, alkyl chain functional groups, and/or endo-dicyclopentadiene. In some embodiments, the monomer solution can include N-vinyl 2-pyrrolidone (NVP), 2-hydroxyethyl methacrylate (HEMA), 3-[2-(Methacryloyloxy) ethyl] dimethylammonio] propane-1-sulfonate (DMAPS), and/or 4-penten-1-ol.

In some embodiments, the monomer solution can include the one or more monomers dissolved in a suitable solvent. In some embodiments, the solvent of the monomer solution can be water. In some embodiments, the solvent of the monomer solution can be and/or include one or more organic solvents such as, for example, acetone, benzene, butanol, chloroform, diethyl ether, ethanol, hexane, toluene, or the like. The monomer solution can include the one or more monomers dissolved in a solvent at a monomer concentration. In some embodiments, the monomer concentration of monomer solution can be at least about 50 mM, at least about 75 mM, at least about 100 mM, at least about 125 mM, at least about 150 mM, at least about 175 mM, at least about 200 mM, at least about 250 mM, at least about 300 mM, at least about 350 mM, at least about 400 mM, at least about 450 mM, or at least about 500 mM, inclusive of all values and ranges therebetween. In some embodiments, the monomer concentration of the monomer solution can be no more than about 560 mM, no more than about 520 mM, no more than about 480 mM, no more than about 440 mM, no more than about 400 mM, no more than about 360 mM, no more than about 320 mM, no more than about 280 mM, no more than about 240 mM, no more than about 200 mM, no more than about 160 mM, no more than about 120 mM, no more than about 80 mM, or no more than about 40 mM, inclusive of all values and ranges therebetween.

The method 400 optionally includes at step 404, drying the support and/or substrate material at a predetermined temperature for a period of time. In some embodiments, the support and/or substrate material can be subjected to a drying procedure at a predetermined temperature for a period of time with the purpose of adjusting a concentration of the one or more monomers on the support and/or substrate material prior to initiating chemical reactions to couple surface functional groups and produce a functionalized support. In some embodiments, exposure to the monomer solution at step 402 may saturate the support and/or substrate material in the one or more monomers, resulting in unfavorable and/or undesired concentrations for the free radical co-polymerization reactions used to couple surface functional groups and produce the functionalized support. In such embodiments, the support and/or substrate material may be dried at a predetermined temperature for a period of time to reduce the concentration of the one or more monomers on the support and/or substrate material. Furthermore, in some embodiments, excess amounts of the monomer solution may be removed and/or poured off from the support and/or substrate material prior to drying the support and/or substrate material at the predetermined temperature. In some embodiments, the drying of the support and/or substrate material can be integrated into a roll-to-roll process. In such embodiments, the support and/or substrate material can be disposed in a roll-to-roll coating device line which contains at least one heat treatment module. The support and/or substrate material can be directed to the heat treatment module where the support and/or substrate material can be dried in a furnace and/or oven included in the heat treatment station at a predetermined temperature for a period of time. In some embodiments, the predetermined temperature can be at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 110° C., at least about 120° C., at least about 130° C., or at least about 140° C., inclusive of all values and ranges therebetween. In some embodiments the predetermined temperature can be no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., no more than about 35° C., inclusive of all values and ranges therebetween. Combinations of the above referenced ranges for the predetermined temperature are also possible (e.g., at least about 110° C. to less than about 120° C., or at least about 38° C. to less than about 55° C.). The support and/or substrate material can be dried at step 404 for a selected period of time. In some embodiments, this period of time can be no more than about 10 min, no more than about 9 min, no more than about 8 min, no more than about 7 min, no more than about 6 min, no more than about 5 min, no more than about 4 min, no more than about 3 min, no more than about 2 min, or no more than about 1 min, inclusive of all values and ranges therebetween.

Alternatively, in some embodiments, the support and/or substrate material may not need to be dried at a predetermined temperature for a period of time. Instead, the support and/or substrate material may be directly subjected to the step 405, as further described herein. For example, in some embodiments the one or more monomers disposed on the support and/or substrate material at step 403 can include at least one volatile monomer (e.g., a monomer which can be readily vaporized). In such embodiments, drying the support and/or substrate material may cause excessive loss of the volatile monomer(s), which may result in poor and/or deficient co-polymerization reactions to couple surface functional groups and produce a functionalized support. Consequently, in some embodiments the support and/or substrate material may not be dried at a predetermined temperature for a period of time. It is worth noticing that in some embodiments, the support and/substrate material may not be dried at step 404 and instead be subjected to step 405 while the support and/substrate material is still being exposed to the monomer solution at step 403 (e.g., the support and/substrate material is disposed on a container filled with the monomer solution, or is rinsed, sprinkled, or sprayed with the monomer solution).

At step 405, the method 400 includes activating the support material to couple surface functional groups to the support and/or substrate material and produce a functionalized support. As described above, a functionalized support can be fabricated by exposing the one or more monomers and the support and/or substrate material to an activation procedure. The activation procedure consists of transferring energy to the support and/or substrate material, and more specifically to PES included in the support and/or substrate material, to catalyze the formation of sulfonyl and/or aryl radicals, which in turn react with the one or more monomers via free radical co-polymerization reactions producing surface functional groups covalently bound and/or grafted to the support and/or substrate material. In some embodiments, activating the support and/or substrate material includes exposing PES included in the support and/or substrate material and the one or more monomers to Ultraviolet (UV) light to initiate free radical co-polymerization reactions (e.g., activation via UV-induced free radical co-polymerization). In such embodiments, the support and/or substrate material can be disposed at a close distance from a UV light source to irradiate UV light on the support and/or substrate material for a time interval and/or period of time sufficient to activate the support and/or substrate material and initiate the free radical co-polymerization reactions. In some embodiments, the time interval and/or period of time to activate the support and/or substrate material and initiate the free radical co-polymerization reactions during UV-induced activation can be no more than about 10 min, no more than about 9 min, no more than about 8 min, no more than about 7 min, no more than about 6 min, no more than about 5 min, no more than about 4 min, no more than about 3 min, no more than about 2 min, or no more than about 1 min, inclusive of all values and ranges therebetween. In some embodiments, the support and/or substrate material can be exposed to an inert gas such as N₂ and/or Argon after UV illumination to preserve and/or extend the life of the activated sites and facilitate the co-polymerization to produce the functionalized support 200.

It is worth noting that these time intervals and/or periods of time for activating the support and/or substrate material (e.g., UV-induced activation) at step 405 of the method 400 are significantly shorter than those used during conventional methods to activate a support material to couple surface functional groups via free-radical co-polymerization reactions with monomers. For example, conventional methods to activate a support material to couple surface functional groups can require exposure to a UV light source for a time interval and/or period of time of at least about 20 min, at least about 25 min, about 30 min or even more. Despite the relatively short time intervals and/or periods of time of activation of the support material by exposure to a UV light source at step 405, the method 400 produces functionalized supports which contain a high density of surface functional groups and enables the fabrication of a filtration apparatus 1000 that exhibits the high performance shown, for example, in FIGS. 3A, 3B and 4, and the improved thermal stability shown, for example, in FIG. 2. These short time intervals and/or periods of time for activation of the support and/or substrate material provide an important advantage for the large scale and low-cost fabrication of the functionalized support 200 and the filtration apparatus 1000. More specifically, the short time intervals and/or periods of time for the activation of the support and/or substrate material allows integrating step 405 to a roll-to-roll process to produce large quantities of the filtration apparatus 1000 continuously. For example, in some embodiments the support and/or substrate material can be conveyed along a roll-based processing line of a roll-to roll coating device and be directed to a UV light source to activate the support and/or substrate material. In some implementations, one or more UV light sources can be disposed on the front end (or alternatively the back end) of a furnace and/or oven included in the roll-to-roll coating device to expose the support and/or substrate material to UV light for the time intervals and/or periods of time disclosed above. Since previously disclosed and/or conventional methods to activate a support material to couple surface functional groups require significantly larger time intervals and/or periods of time to achieve the coupling of surface functional groups, their ability to be integrated into a continuous roll-to-roll process may be limited.

In some embodiments, activating the support and/or substrate material includes exposing PES included in the support and/or substrate material and the one or more monomers to a corona discharge and/or any suitable high-energy treatment such as plasma, ozone, and/or an electron beam to initiate free radical co-polymerization reactions (e.g., activation via high-energy treatment induced free radical co-polymerization). In such embodiments, a high-energy treatment device can be positioned at a close distance from the support and/or substrate material to expose the support and/or substrate material to a high-energy treatment (e.g., corona discharge, electron beam, a plasma etc.) for a time interval and/or period of time sufficient to activate the support and/or substrate material and initiate the free radical co-polymerization reactions. The time intervals and/or periods of time required to activate the support and/or substrate material and initiate the free radical co-polymerization reactions during the high-energy treatment induced activation can be similar and/or the same as the UV-induced activation time intervals and/or periods of time disclosed above. Furthermore, the short time intervals and/or periods of time required for activating the support and/or substrate material via the high-energy treatment induced activation can also produce functionalized supports which contain a high density of surface functional groups and enable the fabrication of a filtration apparatus 1000 that exhibits the high performance shown, for example, in FIGS. 3A, 3B and 4, and the improved thermal stability shown, for example, in FIG. 2. As described above, these short time intervals and/or periods of time for activation of the support and/or substrate material facilitate the large scale and low-cost fabrication of the functionalized support 200 and the filtration apparatus 1000, by integrating step 405 of the method 400 into a roll-to-roll process. For example, in some embodiments the support and/or substrate material can be conveyed along a roll-based processing line of a roll-to roll coating device and be directed to a high-energy treatment unit/device to activate the support and/or substrate material. In some implementations, one or more high-energy treatment units/devices can be disposed on the back end (or alternatively the front end) of a furnace and/or oven included in the roll-to-roll coating device to expose the support and/or substrate material to a high-energy treatment for the time intervals and/or periods of time disclosed above.

In some embodiments, activating the support and/or substrate material includes exposing PES included in the support and/or substrate material and the one or more monomers to an activation temperature to initiate free radical co-polymerization reactions (e.g., activation via thermally induced free radical co-polymerization). In such embodiments, an oven and/or furnace can be used to heat the support and/or substrate material to an activation temperature for a time interval and/or period of time sufficient to activate the support and/or substrate material and initiate the free radical co-polymerization reactions. In some embodiments, the activation temperature can be at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 110° C., at least about 120° C., at least about 130° C., or at least about 140° C., inclusive of all values and ranges therebetween. In some embodiments, the activation temperature can be no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., no more than about 35° C., inclusive of all values and ranges therebetween. Combinations of the above referenced ranges for the activation temperature are also possible (e.g., at least about 110° C. to less than about 120° C., or at least about 38° C. to less than about 55° C.).

The time intervals and/or periods of time required to activate the support and/or substrate material and initiate the free radical co-polymerization reactions during thermally induced activation can be similar and/or the same as the UV-induced activation, and the corona treatment induced activation described above. These short time intervals and/or periods of time can also produce functionalized supports which contain a high density of surface functional groups and enable the fabrication of a filtration apparatus 1000 that exhibits the high performance shown, for example, in FIGS. 3A, 3B and 4, and the improved thermal stability shown, for example, in FIG. 2. Consequently, the short time intervals and/or periods of time for the thermal activation of the support and/or substrate material facilitate the large scale and low-cost fabrication of the functionalized support 200 and the filtration apparatus 1000 by integrating step 405 of the method 400 to a roll-to-roll process. For example, in some embodiments the support and/or substrate material can be conveyed along a roll-based processing line of a roll-to roll coating device and be directed to an oven and/or furnace to activate the support and/or substrate material. In some implementations, an oven and/or furnace of the roll-to-roll coating device can be programmed to heat the support and/or substrate material to the activation temperature and expose the support and/or substrate material to the activation temperature for the time intervals and/or periods of time disclosed above.

FIG. 7A shows a schematic representation of an example UV activated, high energy treatment activated, and/or thermally activated chemical reaction between a support and/or substrate comprising PES and allylamine monomer, producing a functionalized support 200 with allylamine surface functional groups. As described above, the functionalized support 200 can be fabricated by modifying a polymeric support and/or substrate material comprising PES to bind surface functional groups. In some embodiments, a plurality of surface functional groups can be bound and/or grafted to PES by activation via UV light initiated chemical reactions without the presence of photo initiators. In some embodiments, a plurality of surface functional groups can be bound and/or grafted to PES by activation via a high energy treatment initiated chemical reactions. In some embodiments, a plurality of surface functional groups can be bound and/or grafted to PES by activation via thermally initiated chemical reactions. Sulfonyl groups present in the PES polymer chains and/or one or more monomers such as those described herein can be activated by exposure to UV light, a corona discharge, an electron beam, a plasma, ozone, or other high energy treatments, and or an activation temperature, to generate free radicals that initiate co-polymerization reactions. For example, in some embodiments, a polymeric support material comprising PES can be exposed to a UV light source, a plasma treatment, and/or a thermal activation step for a period of time to induce co-polymerization of a suitable monomer, such as an allyl monomer and/or a vinyl monomer. In some embodiments, the UV initiated reactions between the PES polymeric support material and a suitable monomer can be conducted under an inert atmosphere, buy introducing an inert gas such as Nitrogen, Argon, Helium, and the like.

In some embodiments, a functionalized support 200 can be fabricated by exposing a polymeric material comprising PES to a UV light of a wavelength of about 100 nm, about 150 nm, about 200 nm, about 250 nm, about 300 nm, about 350 nm, or about 400 nm, inclusive of all values and ranges therebetween.

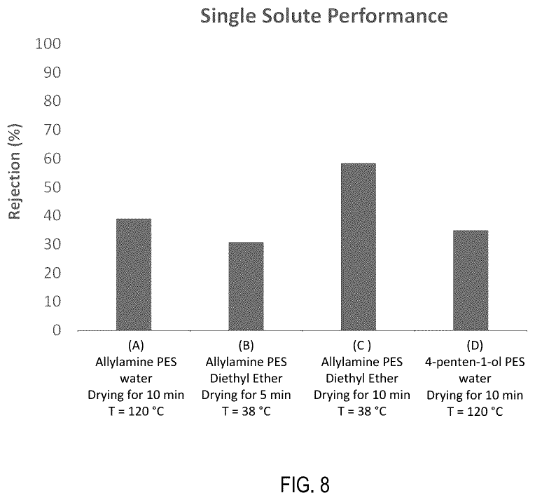

FIG. 8 shows the rejection of various functionalized supports 200 for the filtration of solutions containing a single solute species, illustrating the effect of the drying conditions at step 404 of the method 400, for different monomer solutions (allylamine in water, allylamine in diethyl ether, and 4-penten-1-ol in water) activated via UV induced free radical co-polymerization reactions. The rejection rates shown in FIG. 8 were measured using a dead-end filtration cell, flowing single solute aqueous solutions containing 1 wt. % (10,000 ppm) of Sodium Chloride (NaCl, 58 Da, −1 charge), at room temperature (e.g., 25° C.), and a pressure of 200 or 250 psi. The rejection rates were determined using a conductivity method. FIG. 8 shows filtration of the 1 wt. % NaCl solution with the functionalized support A (e.g., an allylamine PES functionalized support 200 prepared using an allylamine/water monomer solution, drying the monomer solution for 10 min at 120° C.) displayed an average rejection rate of about 39%. The functionalized support B (e.g., an allylamine PES functionalized support 200 prepared using an allylamine/diethyl ether monomer solution, drying the monomer solution for 5 min at 38° C.) displayed an average rejection rate of about 31%, evidencing a reduction of 21% in the average rejection rate when the solvent of the monomer solution is changed from water to diethyl ether. Despite this reduction in the average rejection rate, it is worth noting that the drying conditions for the diethyl ether monomer solution in the functionalized support B include a much lower drying predetermined temperature and a much lower drying period of time. Consequently, fabrication of functionalized supports 200 using diethyl ether monomer solution may provide an approach to reduce the drying conditions and expedite the fabrication of the functionalized support 200. Furthermore, FIG. 8 shows that filtration of the 1 wt. % NaCl solution with the functionalized support C (e.g., an allylamine PES functionalized support 200 prepared using an allylamine/diethyl ether monomer solution, drying the monomer solution for 10 min at 38° C.) resulted in an increased average rejection rate of about 58.5%. This increase in the average rejection rate of the functionalized support C with respect to the functionalized supports A and B suggests that fabrication of functionalized supports with allylamine monomer may exhibit higher performances when the monomer solution includes an organic solvent such as diethyl ether and require a relatively low predetermined drying temperature (e.g., 38° C.). Filtration of the 1 wt. % NaCl solution with the functionalized support D (e.g., a 4-penten-1-ol PES functionalized support 200 prepared using a 4-penten-1-ol/water monomer solution, drying the monomer solution for 10 min at 120° C.) resulted in an average rejection rate of about 34.9%. This average rejection rate is in line with that observed with the functionalized support A, suggesting that careful selection of the solvent of the monomer solution may be provide an approach to produce functionalized supports 200 at moderate drying temperatures and using short predetermined drying times.

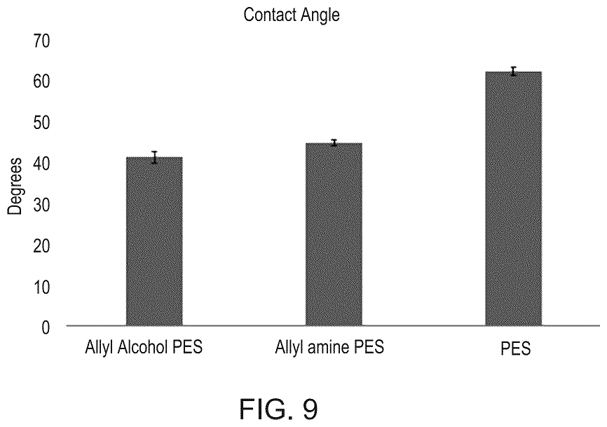

In some embodiments, the incorporation of selective surface functional groups covalently bound to the functionalized support 200 can cause the functionalized support 200 to exhibit wettability or hydrophilicity. For example, in some embodiments a PES functionalized support 200 can be modified to include allylamine surface functional groups. The allylamine surface functional groups can cause the functionalized support 200 to show an increased hydrophilicity, as evidenced by static measurements of water contact angle measurements. FIG. 9 shows the contact angle of a PES support, an allylamine PES functionalized support 200, and an allyl alcohol PES functionalized support 200, evidencing the increased hydrophilicity of the functionalized support 200 due to incorporation of surface functional groups. More specifically, FIG. 9 shows incorporation of allylamine surface functional groups to the PES functionalized support 200 resulted in a decrease in the static water contact angle, which changed from 62.6° for the PES support to 45° for the allylamine PES functionalized support 200. Similarly, incorporation of allyl alcohol surface functional groups to the PES functionalized support 200 resulted in a decrease in the static water contact angle from 62.6° for the PES support to 41.5° for the allyl alcohol PES functionalized support 200. As described above, the increased hydrophilicity of the functionalized support 200 can facilitate adequately matching the hydrophilicity/hydrophobicity of solutions containing graphene oxide and/or other chemical species employed in the fabrication of the graphene oxide membrane 100. In that way, the surface functional groups of the functionalized support 200 can facilitate the formation of a high-quality filtration apparatus 1000 with a graphene oxide membrane 100 free of defects (e.g., pinholes, flakes, cracks, rough surface spots, etc.).

### Applications

The filtration apparatus 1000 and/or the functionalized support 200 disclosed herein can be used for a wide range of nanofiltration or microfiltration applications, including but not limited to, concentration of molecules (e.g., whey, lactose), kraft pulping (e.g., wood pulp), sulfite pulping, demineralization or desalting (e.g., lactose, dye, chemicals, pharmaceuticals), fractionation (e.g., sugars), extraction (e.g., nutraceuticals, plant oils), recovery (e.g., catalyst, solvent), and purification (e.g., pharmaceutical, chemical, fuel), as well as applications in which high chemical stability and high monovalent and divalent ion rejection are required, such as acid concentration, sucrose concentration, and/or homogeneous catalyst concentration and/or purification. For example, a fluid comprising a plurality of species (e.g., plurality of retentate species) may be placed in contact with a first side of the graphene oxide membrane 100. The graphene oxide membrane 100 may have interlayer spacing and/or intralayer spacing that are sized to prevent at least a portion of the species from traversing the membrane through the interlayer spacing and/or intralayer spacing, i.e., flowing from the first side of the graphene oxide membrane and to a second, opposing side of the graphene oxide membrane 100. In some embodiments, the fluid may include one or more types of species (e.g., a retentate species or a permeate species). In some embodiments, the graphene oxide membrane 100 may have an average interlayer spacing and/or intralayer spacing that is sized to prevent at least a portion of the retentate species from traversing the graphene oxide membrane, while allowing at least a portion (e.g., substantially all) of the permeate species to traverse the graphene oxide membrane.

The filtration apparatus 1000 and/or the functionalized support 200 disclosed herein can also be used for the concentration of black liquor. Black liquor is a byproduct of the kraft pulping process which is generated during digestion of pulpwood to produce cellulose fibers for pulp and paper products. Pulp mills generally process black liquor using thermal evaporators to increase the solids content in the Black Liquor. The high solids content Black liquor is then burned in a recovery boiler to generate steam and provide energy to the pulp mill. Thermal evaporation is a slow and energy intensive process that negatively impacts the kraft mill energy consumption, efficiency, and cost. Consequently, concentration of black liquor by pressure driven membrane systems is attractive approach to increase the energy efficiency of the environmental impact of the mill operation. Weak black liquor (WBL), a form of black liquor which has low solids content (e.g., 15-20%), is generally produced from pulp digestion at a temperature of about 80° C. to 90° C. Exposure of WBL to conventional membrane systems at these temperature results in rapid degradation of the membranes, which are typically made of polymeric materials. Cooling the WBL prior to filtration would be very expensive and energy intensive. Without the need for cooling, the WBL can pass through a filtration apparatus comprising the graphene oxide membrane described herein at a high temperature, e.g., 80° C. to 90° C. or 75° C. to 85° C. In some embodiments, WBL can be flowed through the filtration apparatus 1000 described herein, wherein the WBL comprises lignin, sodium sulfate, sodium carbonate, sodium hydrosulfide, sodium thiosulfate, sodium hydroxide, as well as larger size organic species including hemicellulose, cellulose, and lignin.

Processing of WBL using the filtration apparatus 1000 typically requires receiving a WBL stream, conducting one or more initial processing steps to precondition the WBL stream (e.g., remove large particles, residues, oils, and other high molecular weight organic species suspended in the WBL), and then flow the preconditioned WBL through a series of filtration modules, which can also be referred to as filtration passes. Each filtration pass can include one or more filtration apparatus 1000 disposed in series and/or parallel configuration. At a first filtration pass, the preconditioned WBL stream can be flowed through the one or more filtration apparatus 1000 included in the first filtration pass at a first temperature. The first temperature being between about 60° C. and 90° C. Selected species included in the preconditioned WBL stream may be allowed to diffuse across the filtration apparatus 1000 in the first filtration pass to produce a first permeate stream. Other species present in the preconditioned WBL may be rejected by the filtration apparatus 1000 (e.g., being prevented from diffusing across the graphene oxide membrane 100 and/or the functionalized support 200) and produce a first concentrate stream. Typically, a first filtration pass may receive the preconditioned WBL and produce a first concentrate that contains primarily organic species such as lignin and/or hemicellulose, and a first permeate that contains predominantly monovalent and divalent salts. Removal of these monovalent and divalent salts as well as any organic species that may have diffused through the filtration apparatus 1000 requires feeding the first permeate to one or more successive filtration passes (e.g., a second pass, a third pass, a fourth pass and so on). At each filtration pass, a filtration apparatus 1000 receives a feed (e.g., a permeate stream from a previous filtration pass). This feed is received in the filtration pass at a specific temperature and having a specific chemical composition. The performance of the filtration apparatus 1000 included in each filtration pass greatly depends on the temperature and the composition of the feed at that filtration pass.

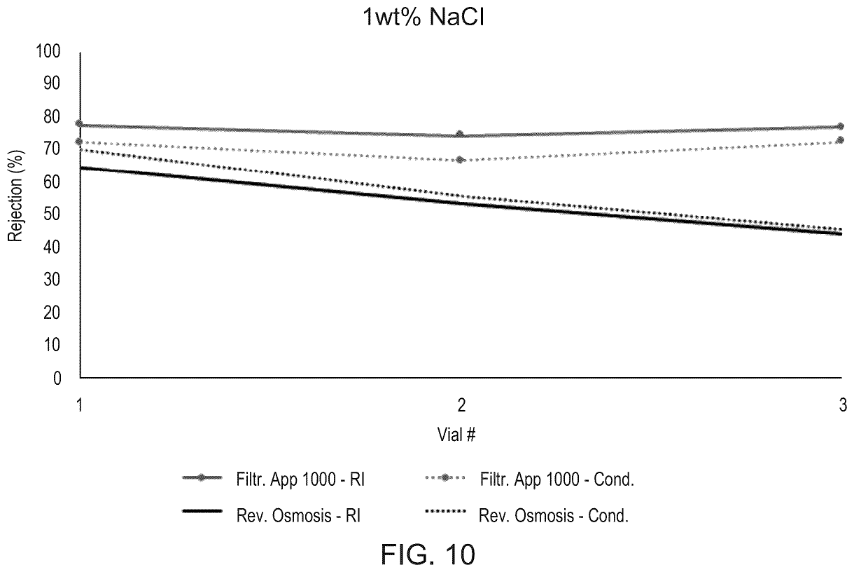

FIG. 10 shows the performance of a filtration apparatus 1000 and a reverse osmosis membrane in flowing a 1 wt. % sodium chloride (NaCl) solution. The filtration apparatus 1000 in FIG. 10 included a graphene oxide membrane 100 including a propionamide spacer fabricated as described in the '227 patent (incorporated by reference above), and an allylamine PES functionalized support 200 fabricated as described above with reference to the method 400. The reverse osmosis membrane was obtained from a commercial vendor (Dupont Filmtec Membranes, SW30HRLE). The rejection rates (%) shown in FIG. 10 were measured using a dead-end filtration cell, flowing the 1 wt. % NaCl solution at room temperature (e.g., 25° C.), and 250 psi, determining the rejection rate using both refractive index (RI) and a conductivity method (Cond.). FIG. 10 shows the filtration apparatus 1000 exhibited rejection rates of about 70% to 80% measured by refractive index (RI) and conductivity (Cond.) for three independent experiments (e.g., vial #1, 2 and 3), whereas the reverse osmosis membrane displayed lower rejection rates of about 50% to 60%. It is important to note that additional experiments (not shown) using a propionamide spacer graphene oxide membrane 100, a PES support (e.g., a support made of and/or including a polymeric membrane comprising PES and no surface functional groups grafted to the PES) and/or a combination of the propionamide spacer graphene oxide membrane 100 and the PES support, did not reject NaCl (e.g., displayed rejection rates of about 0% in the 1 wt. % NaCl solution). These results further confirm that the use of the filtration apparatus can be valuable for the rejection of small size single solute species which may be present in a WBL solution.

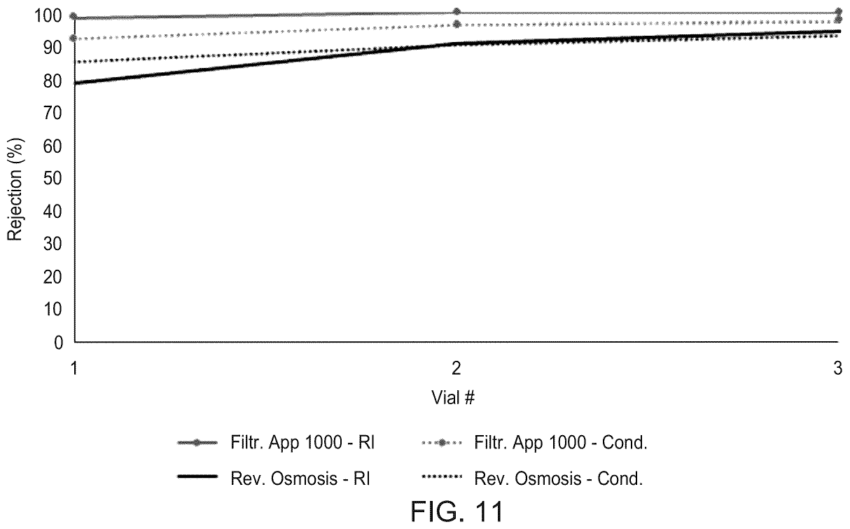

FIG. 11 shows the performance of the filtration apparatus 1000 and the reverse osmosis membrane shown in FIG. 10, in flowing an example diluted WBL solution comprising sodium sulfate, sodium carbonate, sodium hydrosulfide, sodium thiosulfate, sodium hydroxide, as well as larger size organic species including hemicellulose, cellulose, and lignin. The rejection rates (%) shown in FIG. 11 were using a dead-end filtration cell operating in the diluted WBL solution at room temperature (e.g., 25° C.), and 250 psi. The performance data in FIG. 11 reveals that the filtration apparatus 1000 can achieve rejection rates of about 98% to 100% in the WBL solution as measured by refractive index (RI), and about 95% to about 97% as measured by conductivity (Cond). The rejections rates are higher than those observed with the reverse osmosis membrane, which achieved a rejection rate of about 78% to about 92% measured by RI and Cond.

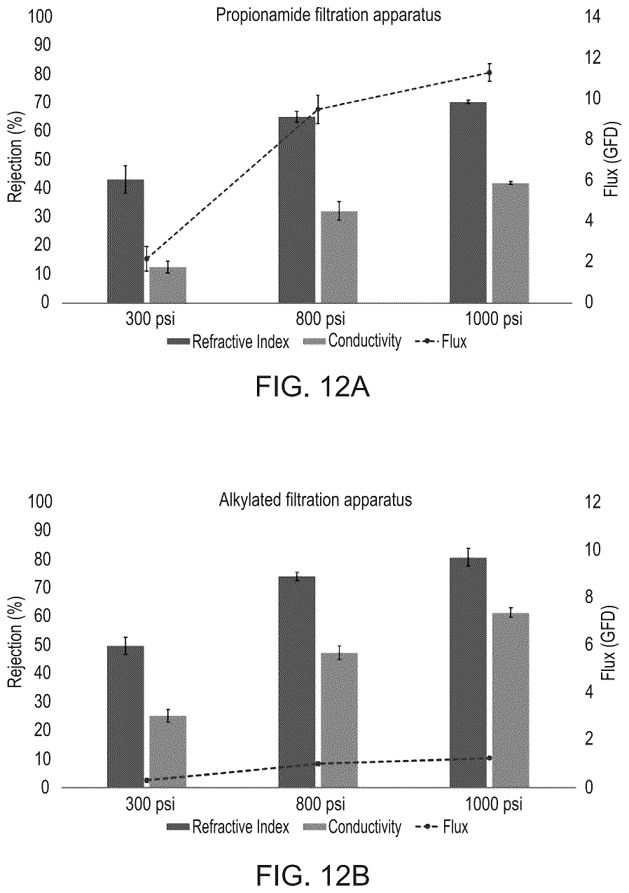

FIGS. 12A and 12B show the rejection rate (%) and flux (GFD, Gal/ft2/day) of two different filtration apparatus 1000 in flowing a WBL feed. FIG. 12A shows the performance of a filtration apparatus 1000 comprising a propionamide graphene oxide membrane 100 and an allylamine PES functionalized support 200, which can also be referred to herein as a “propionamide filtration apparatus 1000.” The propionamide graphene oxide membrane 100 in the propionamide filtration apparatus 1000 can be fabricated as described in the '227 patent, incorporated by reference above. Similarly, FIG. 12B shows the performance of a filtration apparatus 1000 comprising an alkylated graphene oxide membrane and an allylamine PES functionalized support 200, which can also be referred to herein as an “alkylated filtration apparatus 1000.” The alkylated graphene oxide membrane 100 in the alkylated filtration apparatus 1000 can be fabricated as disclosed in the '051 application, incorporated by reference above. The allylamine PES functionalized support 200 in the filtration apparatus 1000 in FIGS. 12A and 12B can be prepared according to the method 400 described above. The rejection rate (%) and flux (GFD) shown in FIGS. 12A and 12B were measured in a crossflow filtration cell, flowing the WBL feed at a temperature of about 60° C., a pressure of 300 psi, 800 psi, and 1000 psi. The WBL feed in FIGS. 12A and 12B corresponds to a permeate stream obtained after a black liquor (Arkansas Pulp Mill) is exposed to a first filtration pass. This permeate stream, which is characterized r Index RI=7 Brix, and a Conductivity=46 mS, was fed to the filtration apparatus 1000 in FIGS. 12A-12B to simulate the potential performance of the filtration apparatus 1000 when included in a second filtration pass.

FIGS. 12A and 12B show the performance of the filtration apparatus 1000, both in terms of rejection rate and flux, increases at higher operating pressures. Consequently, the overall best performance, understood as the combination of rejection rate and flux, was observed when operating at a pressure of 1000 psi for both filtration apparatus (e.g., the propionamide filtration apparatus 1000 and the alkylated filtration apparatus 1000). Further observation of FIGS. 12A and 12B reveals that increasing the operating temperature from 800 psi to 1000 psi results in an increase in the rejection rate (measured via conductivity method) of about 10% for the alkylated filtration apparatus 1000 (FIG. 12B) and about 15% for the propionamide filtration apparatus 1000 (FIG. 12A). Despite having a relatively smaller rejection rate increase when the operating pressure is changed from 800 to 1000 psi, the alkylated filtration apparatus 1000 can displays a conductivity rejection at 800 psi which is about 13-19% higher than the conductivity rejection of the propionamide filtration apparatus 1000 at 800 psi. Unfortunately, the higher rejection rate of the alkylated filtration apparatus 1000 in FIG. 12B is accompanied by a significantly low flux of only about 1 to 2 GFD. In contrast, the propionamide filtration apparatus in FIG. 12A display a flux of about 12 GFD at a pressure of 1000 psi. The high rejection rate and high flux shown in FIG. 12A provide experimental evidence of the ability of the propionamide filtration apparatus 1000 to operate as a second filtration pass.

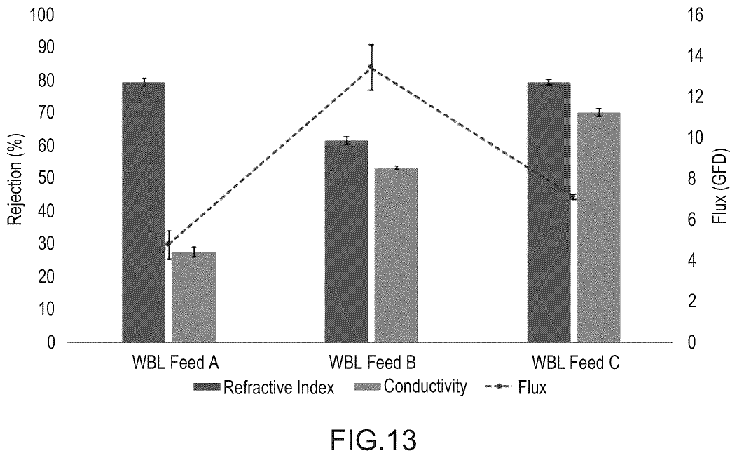

FIG. 13 shows a chart displaying a comparison of the performance (e.g., rejection rate (5) and flux (GFD)) expected from an example filtration apparatus 1000 comprising a propionamide graphene oxide membrane 100 and an allylamine PES functionalized support 200, during operation in three different WBL feeds (e.g., WBL feeds A, B, and C). The rejection in FIG. 13 was measured via refraction index (RI) and the conductivity (Cond.). The propionamide graphene oxide membrane 100 in FIG. 13 can be fabricated as described in the '227 patent, incorporated by reference above. The allylamine PES functionalized support 200 in FIG. 13 can be prepared as described in the method 400 described above. The WBL feed A in FIG. 13 is characterized by a refractive index RI=17.3 Brix, a total dissolved solids (TSD)=˜13.2%, and a conductivity of about 55 mS. The characteristics of the WBL feed A were selected to simulate the performance of the propionamide filtration apparatus 1000 when operating in an example WBL feed which has not been subjected to any prior filtration pass (e.g., WBL feed A may simulates an example first filtration pass feed). The WBL feed B is characterized by a refractive index RI=7.2 Brix, a total dissolved solids (TSD)=˜6.1%, and a conductivity of about 50 mS. The characteristics of the WBL feed B were selected to simulate the performance of the propionamide filtration apparatus 1000 when operating in a potential example permeate stream obtained from a prior filtration pass (e.g., WBL feed B may simulated an example second filtration pass feed). Similarly, The WBL feed C is characterized by a refractive index RI=3.6 Brix, a total dissolved solids (TSD)=˜3.5%, and a conductivity of about 30 mS. The characteristics of the WBL feed C were selected to simulate the performance of the propionamide filtration apparatus 1000 when operating in a potential example permeate stream obtained from prior filtration es (e.g., WBL feed C may simulated an example third filtration pass feed).

FIG. 13 shows the flux of the propionamide filtration apparatus 1000 displays a considerable increase from about 4.8 GFD to about 9.5 GFD when the propionamide filtration apparatus 1000 is transitioned from operating in WBL feed A to operating in WBL feed B. However, further transitioning the propionamide filtration apparatus 1000 from operating in WBL feed B to operating in WBL feed C, reduced the flux of the propionamide filtration apparatus 1000 to about 7 GFD. The rejection rate of the propionamide filtration apparatus 1000 measured by refractive index (RI) gradually increased when the propionamide filtration apparatus 1000 is transitioned from operating in the WBL feed A, the WBL feed B, and then the WBL feed C. Unlike the RI rejection rate, the conductivity rejection rate (Cond) of the propionamide filtration apparatus 1000 decreased about 14% when the propionamide filtration apparatus 1000 is transitioned from operating in the WBL feed A to the WBL feed B. However, the combination of high rejection rates (RI and Cond) and the relatively high fluxes shown in FIG. 13 provide evidence of the high performance of a filtration apparatus 1000 which includes a functionalized support 200 in a wide variety of feeds.

In some embodiments, the filtration apparatus 1000 can be configured to operate in a WBL feed characterized by a total dissolved solids (TDS) of at least about 1.5%, at least about 2%, at least about 3%, at least about 4%, at least about 5%, at least about 6%, at least about 8%, at least about 10%, at least about 1%, at least about 14%, at least about 16%, at least about 18%, at least about 20%, or at least about 24%, inclusive of all values and ranges therebetween. In some embodiments, the filtration apparatus 1000 can be configured to operate in a WBL feed characterized by a total dissolved solids (TDS) of no more than about 24%, no more than about 21%, no more than about 18%, no more than about 15%, no more than about 12%, no more than about 9%, no more than about 6%, no more than about 5%, no more than about 4%, or no more than about 2%, inclusive of all values and ranges therebetween.

The performance of the filtration apparatus and/or the functionalized support 200 for WBL filtration can be assessed by the rejection rate on a total solids basis. In some embodiments, the rejection rate is between about 75% and about 95% on a total solids basis, e.g., between about 75% and about 90%, between about 75% and about 85%, or between 80% and about 95% on a total solids basis.

In some embodiments, the filtration apparatus 1000 and/or the functionalized support 200 can reject at least a portion of the lignin. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the lignin.

In some embodiments, the filtration apparatus 1000 and/or the functionalized support 200 can reject at least a portion of the sodium sulfate. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the sodium sulfate.

In some embodiments, the filtration apparatus 1000 and/or the functionalized support 200 can reject at least a portion of the sodium carbonate. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the sodium carbonate.

In some embodiments, the filtration apparatus 1000 and/or the functionalized support 200 can reject at least a portion of the sodium hydrosulfide. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the sodium hydrosulfide.

In some embodiments, the filtration apparatus 1000 and/or the functionalized support 200 can reject at least a portion of the sodium thiosulfate. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the sodium thiosulfate.

In some embodiments, the filtration apparatus 1000 and/or the functionalized support 200 can reject at least a portion of the sodium hydroxide. In some embodiments, the filtration apparatus 1000 and/or the functionalized support 200 can reject at least about 50%, at least about 60%, at least about 70%, at least about 80%, at least about 90%, at least about 95%, at least about 96%, at least about 97%, at least about 98%, at least about 99%, or at least about 99.5% of the sodium hydroxide.

The filtration apparatus 1000 disclosed herein can be used in reverse osmosis to remove ions, molecules, and larger particles from a fluid, e.g., drinking water.

In some embodiments, the filtration apparatus 1000 and/or the functionalized support 200 disclosed herein can be used in methods for filtering raw milk, cheese whey, whey protein concentrate, mixtures comprising lactose, and whey protein isolate. The methods can include flowing the raw milk through the graphene oxide membrane.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially,” “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “graphene oxide sheet” means a single atomic graphene oxide layer or a plurality of atomic graphene oxide layers. Each atomic graphene oxide layer may include out-of-plane chemical moieties attached to one or more carbon atoms on the layer. In some embodiments, the term “graphene oxide sheet” means 1 to about 20 atomic graphene oxide layers, e.g., 1 to about 18, 1 to about 16, 1 to about 14, 1 to about 12, 1 to about 10, 1 to about 8, 1 to about 6, 1 to about 4, or 1 to about 3 atomic graphene oxide layers. In some embodiments, the term “graphene oxide sheet” means 1, 2, or 3 atomic graphene oxide layers.

As used herein, the term “basic” means pH greater than 7.

As used herein, “wt. %” refers to weight percent.

As used herein, the term “flux” means flow rate. It describes the permeability of a membrane.

As used herein, the term “optionally substituted” is understood to mean that a given chemical moiety (e.g., an alkyl group) can (but is not required to) be bonded other substituents (e.g., heteroatoms). For instance, an alkyl group that is optionally substituted can be a fully saturated alkyl chain (i.e., a pure hydrocarbon). Alternatively, the same optionally substituted alkyl group can have substituents different from hydrogen. For instance, it can, at any point along the chain be bounded to a halogen atom, a hydroxyl group, or any other substituent described herein. Thus the term “optionally substituted” means that a given chemical moiety has the potential to contain other functional groups, but does not necessarily have any further functional groups. Suitable substituents used in the optional substitution of the described groups include, without limitation, halogen, oxo, —OH, —CN, —COOH, —CH2CN, —O—(C1-C6) alkyl, (C1-C6) alkyl, C1-C6 alkoxy, (C1-C6) haloalkyl, C1-C6 haloalkoxy, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, —NH2, —NH((C1-C6) alkyl), —N((C1-C6) alkyl)2, —NHC(O)(C1-C6) alkyl, —C(O)NH(C1-C6) alkyl, —S(O)2(C1-C6) alkyl, —S(O)NH(C1-C6) alkyl, and —S(O)N((C1-C6) alkyl)2. The substituents can themselves be optionally substituted.

As used herein, the term “hydroxy” or “hydroxyl” refers to the group —OH or —O—.

As used herein, “halo” or “halogen” refers to fluoro, chloro, bromo, and iodo.

The term “carbonyl” includes compounds and moieties which contain a carbon connected with a double bond to an oxygen atom. Examples of moieties containing a carbonyl include, but are not limited to, aldehydes, ketones, carboxylic acids, amides, esters, anhydrides, etc.

The term “carboxyl” refers to —COOH or its C1-C6 alkyl ester.

“Acyl” includes moieties that contain the acyl radical (R—C(O)—) or a carbonyl group. “Substituted acyl” includes acyl groups where one or more of the hydrogen atoms are replaced by, for example, alkyl groups, alkynyl groups, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “alkoxy” or “alkoxyl” includes substituted and unsubstituted alkyl, alkenyl and alkynyl groups covalently linked to an oxygen atom. Examples of alkoxy groups or alkoxyl radicals include, but are not limited to, methoxy, ethoxy, isopropyloxy, propoxy, butoxy and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy and trichloromethoxy.

The term “ester” includes compounds or moieties which contain a carbon or a heteroatom bound to an oxygen atom which is bonded to the carbon of a carbonyl group. The term “ester” includes alkoxycarboxy groups such as methoxycarbonyl, ethoxycarbonyl, propoxycarbonyl, butoxycarbonyl, pentoxycarbonyl, etc.

As used herein, “amino” or “amine,” as used herein, refers to a primary (—NH2), secondary (—NHRx), tertiary (—NRxRy), or quaternary amine (—N+RxRyRz), where Rx, Ry, and Rz are independently an aliphatic, alicyclic, heteroaliphatic, heterocyclic, aryl, or heteroaryl moiety, as defined herein. Examples of amine groups include, but are not limited to, methylamine, dimethylamine, ethylamine, diethylamine, methylethylamine, iso-propylamine, piperidine, trimethylamine, and propylamine. “Alkylamino” includes groups of compounds wherein the nitrogen of —NH2 is bound to at least one alkyl group. Examples of alkylamino groups include benzylamino, methylamino, ethylamino, phenethylamino, etc. “Dialkylamino” includes groups wherein the nitrogen of —NH2 is bound to two alkyl groups. Examples of dialkylamino groups include, but are not limited to, dimethylamino and diethylamino. “Arylamino” and “diarylamino” include groups wherein the nitrogen is bound to at least one or two aryl groups, respectively. “Aminoaryl” and “aminoaryloxy” refer to aryl and aryloxy substituted with amino. “Alkylarylamino,” “alkylaminoaryl” or “arylaminoalkyl” refers to an amino group which is bound to at least one alkyl group and at least one aryl group. “Alkaminoalkyl” refers to an alkyl, alkenyl, or alkynyl group bound to a nitrogen atom which is also bound to an alkyl group. “Acylamino” includes groups wherein nitrogen is bound to an acyl group. Examples of acylamino include, but are not limited to, alkylcarbonylamino, arylcarbonylamino, carbamoyl and ureido groups.

The term “amide” or “aminocarboxy” includes compounds or moieties that contain a nitrogen atom that is bound to the carbon of a carbonyl or a thiocarbonyl group. The term includes “alkaminocarboxy” groups that include alkyl, alkenyl or alkynyl groups bound to an amino group which is bound to the carbon of a carbonyl or thiocarbonyl group. It also includes “arylaminocarboxy” groups that include aryl or heteroaryl moieties bound to an amino group that is bound to the carbon of a carbonyl or thiocarbonyl group. The terms “alkylaminocarboxy”, “alkenylaminocarboxy”, “alkynylaminocarboxy” and “arylaminocarboxy” include moieties wherein alkyl, alkenyl, alkynyl and aryl moieties, respectively, are bound to a nitrogen atom which is in turn bound to the carbon of a carbonyl group. Amides can be substituted with substituents such as straight chain alkyl, branched alkyl, cycloalkyl, aryl, heteroaryl or heterocycle. Substituents on amide groups may be further substituted.

Unless otherwise specifically defined, the term “aryl” refers to cyclic, aromatic hydrocarbon groups that have 1 to 3 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment. Exemplary substituents include, but are not limited to, —H, -halogen, —O—(C1-C6) alkyl, (C1-C6) alkyl, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, NH2, NH((C1-C6) alkyl), N((C1-C6) alkyl)2, —S(O)2-(C1-C6) alkyl, —S(O)NH(C1-C6) alkyl, and —S(O)N((C1-C6) alkyl)2. The substituents can themselves be optionally substituted. Furthermore, when containing two fused rings the aryl groups herein defined may have an unsaturated or partially saturated ring fused with a fully saturated ring. Exemplary ring systems of these aryl groups include, but are not limited to, phenyl, biphenyl, naphthyl, anthracenyl, phenalenyl, phenanthrenyl, indanyl, indenyl, tetrahydronaphthalenyl, tetrahydrobenzoannulenyl, and the like.

Unless otherwise specifically defined, “heteroaryl” means a monocyclic aromatic radical of 5 to 24 ring atoms or a polycyclic aromatic radical, containing one or more ring heteroatoms selected from N, O, or S, the remaining ring atoms being C. Heteroaryl as herein defined also means a bicyclic heteroaromatic group wherein the heteroatom is selected from N, O, or S. The aromatic radical is optionally substituted independently with one or more substituents described herein. Examples include, but are not limited to, furyl, thienyl, pyrrolyl, pyridyl, pyrazolyl, pyrimidinyl, imidazolyl, isoxazolyl, oxazolyl, oxadiazolyl, pyrazinyl, indolyl, thiophen-2-yl, quinolyl, benzopyranyl, isothiazolyl, thiazolyl, thiadiazole, indazole, benzimidazolyl, thieno[3,2-b]thiophene, triazolyl, triazinyl, imidazo[1,2-b]pyrazolyl, furo[2,3-c]pyridinyl, imidazo[1,2-a]pyridinyl, indazolyl, pyrrolo[2,3-c]pyridinyl, pyrrolo[3,2-c]pyridinyl, pyrazolo[3,4-c]pyridinyl, thieno[3,2-c]pyridinyl, thieno[2,3-c]pyridinyl, thieno[2,3-b]pyridinyl, benzothiazolyl, indolyl, indolinyl, indolinonyl, dihydrobenzothiophenyl, dihydrobenzofuranyl, benzofuran, chromanyl, thiochromanyl, tetrahydroquinolinyl, dihydrobenzothiazine, dihydrobenzoxanyl, quinolinyl, isoquinolinyl, 1,6-naphthyridinyl, benzo[de]isoquinolinyl, pyrido[4,3-b][1,6]naphthyridinyl, thieno[2,3-b]pyrazinyl, quinazolinyl, tetrazolo[1,5-a]pyridinyl, [1,2,4]triazolo[4,3-a]pyridinyl, isoindolyl, pyrrolo[2,3-b]pyridinyl, pyrrolo[3,4-b]pyridinyl, pyrrolo[3,2-b]pyridinyl, imidazo[5,4-b]pyridinyl, pyrrolo[1,2-a]pyrimidinyl, tetrahydro pyrrolo[1,2-a]pyrimidinyl, 3,4-dihydro-2H-1?2-pyrrolo[2,1-b]pyrimidine, dibenzo[b,d]thiophene, pyridin-2-one, furo[3,2-c]pyridinyl, furo[2,3-c]pyridinyl, 1H-pyrido[3,4-b][1,4]thiazinyl, benzooxazolyl, benzoisoxazolyl, furo[2,3-b]pyridinyl, benzothiophenyl, 1,5-naphthyridinyl, furo[3,2-b]pyridine, [1,2,4]triazolo[1,5-a]pyridinyl, benzo[1,2,3]triazolyl, imidazo[1,2-a]pyrimidinyl, [1,2,4]triazolo[4,3-b]pyridazinyl, benzo[c][1,2,5]thiadiazolyl, benzo[c][1,2,5]oxadiazole, 1,3-dihydro-2H-benzo[d]imidazol-2-one, 3,4-dihydro-2H-pyrazolo[1,5-b][1,2]oxazinyl, 4,5,6,7-tetrahydropyrazolo[1,5-a]pyridinyl, thiazolo[5,4-d]thiazolyl, imidazo[2,1-b][1,3,4]thiadiazolyl, thieno[2,3-b]pyrrolyl, 3H-indolyl, and derivatives thereof. Furthermore, when containing two fused rings the aryl groups herein defined may have an unsaturated or partially saturated ring fused with a fully saturated ring. Exemplary ring systems of these heteroaryl groups include indolinyl, indolinonyl, dihydrobenzothiophenyl, dihydrobenzofuran, chromanyl, thiochromanyl, tetrahydroquinolinyl, dihydrobenzothiazine, 3,4-dihydro-1H-isoquinolinyl, 2,3-dihydrobenzofuran, indolinyl, indolyl, and dihydrobenzoxanyl.

Furthermore, the terms “aryl” and “heteroaryl” include multicyclic aryl and heteroaryl groups, e.g., tricyclic, bicyclic, e.g., naphthalene, benzoxazole, benzodioxazole, benzothiazole, benzoimidazole, benzothiophene, quinoline, isoquinoline, naphthrydine, indole, benzofuran, purine, benzofuran, deazapurine, indolizine.

“Alkyl” refers to a straight or branched chain saturated hydrocarbon. C1-C6 alkyl groups contain 1 to 6 carbon atoms. Examples of a C1-C6 alkyl group include, but are not limited to, methyl, ethyl, propyl, butyl, pentyl, isopropyl, isobutyl, sec-butyl and tert-butyl, isopentyl and neopentyl.

An optionally substituted alkyl refers to unsubstituted alkyl or alkyl having designated substituents replacing one or more hydrogen atoms on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

As used herein, “alkenyl” includes unsaturated aliphatic groups analogous in length and possible substitution to the alkyls described above, but that contain at least one double bond. For example, the term “alkenyl”” includes straight chain alkenyl groups (e.g., ethenyl, propenyl, butenyl, pentenyl, hexenyl, heptenyl, octenyl, nonenyl, decenyl), and branched alkenyl groups.

An optionally substituted alkenyl refers to unsubstituted alkenyl or alkenyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, heterocyclyl, alkylaryl, or an aromatic or heteroaromatic moiety.

“Alkynyl” includes unsaturated aliphatic groups analogous in length and possible substitution to the alkyls described above, but which contain at least one triple bond. For example, “alkynyl” includes straight chain alkynyl groups (e.g., ethynyl, propynyl, butynyl, pentynyl, hexynyl, heptynyl, octynyl, nonynyl, decynyl), and branched alkynyl groups. In certain embodiments, a straight chain or branched alkynyl group has six or fewer carbon atoms in its backbone (e.g., C2-C6 for straight chain, C3-C6 for branched chain). The term “C2-C6” includes alkynyl groups containing two to six carbon atoms. The term “C3-C6” includes alkynyl groups containing three to six carbon atoms.

As used herein, the term “molecular weight cutoff” refers to at least 90% (e.g., at least 92%, at least 95%, or at least 98%) rejection rate for molecules with molecular weights greater than the cutoff value.

As used herein, the term “room temperature” can refer to a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

As used herein, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

As used herein, the term “derivative” refers to a compound that is modified from a parent compound, such that the modified compound and the parent compound have a common core structure, while the parent compound is substituted with one or more substituents as described herein to arrive at the modified compound.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

### Example 1. (HEMA PES Functionalized Support)

A functionalized support was produced according to the following procedure: (1) A polyethersulfone (PES) support was exposed to a cleaning solution, with the cleaning solution being water. The PES support was soaked in the cleaning solution for a period of time of about 48 hours. (2) The PES support was subsequently dried at room temperature for a drying time of about 24 hours. (3) A monomer solution including HEMA monomer and water solvent was prepared by mixing a suitable amount of HEMA monomer in 40 mL of water, producing a 300 mM HEMA monomer solution. The PES support was disposed in the HEMA monomer solution in a petri dish. (4) The PES support was activated via UV-induced activation while the PES support was disposed in the petri dish with the HEMA monomer solution. A UV lamp (Blak-Ray B-100A, high intensity UV lamp, 100 W, 365 nm wavelength) was placed at about 1 inch of the PES support. The PES support was illuminated with the UV lamp for a time interval of about 5 min to produce a HEMA PES functionalized support. (5) The resulting HEMA PES functionalized support was rinsed three times with water and three times with methanol. (6) The HEMA PES functionalized support was dried overnight in a fume hood.

### Example 2. (Allylamine PES Functionalized Support)

A functionalized support was produced according to the following procedure: (1) A polyethersulfone (PES) support was exposed to a cleaning solution, with the cleaning solution being water. The PES support was soaked in the cleaning solution for a period of time of about 24 hours. (2) The PES support was subsequently dried at room temperature for a drying time of about 24 hours. (3) A monomer solution including allylamine monomer and water solvent was prepared by mixing a suitable amount of allylamine monomer in water, producing a 300 mM allylamine monomer solution. The PES support was disposed in the allylamine monomer solution in a petri dish. (4) The PES support was removed from the allylamine monomer solution in the petri dish and excess allylamine monomer solution was poured off from the PES support such that the PES support was only wetted in the allylamine monomer solution. (5) The PES support was activated via a corona discharge treatment induced activation to produce an allylamine PES functionalized support. A hand-held corona treatment device (model BD-20AC corona treater) was displaced over the PES support to expose the PES support to a corona discharge for a time interval of about 5 min. (6) The resulting allylamine PES functionalized support was washed with water two times and with methanol two times. (7) The allylamine PES functionalized support was dried overnight at room temperature.

### Example 3. (Allylamine PES Functionalized Support)

A functionalized support was produced according to the following procedure: (1) A polyethersulfone (PES) support was exposed to a cleaning solution, with the cleaning solution being water. The PES support was soaked in the cleaning solution for a period of time of about 48 hours. (2) The PES support was subsequently dried at room temperature for a drying time of about 24 hours. (3) A monomer solution including allylamine monomer and diethyl ether solvent was prepared by mixing a suitable amount of allylamine monomer in diethyl ether, producing a 300 mM allylamine monomer solution. The PES support was disposed in the allylamine monomer solution in a petri dish. (4) The PES support was removed from the allylamine monomer solution in the petri dish and excess allylamine monomer solution was poured off from the PES support such that the PES support was only wetted in the allylamine monomer solution. (5) The PES support was subsequently dried by disposing the PES support in a drying oven at a predetermined temperature of about 38° C. for a period of time of about 5 min. Alternatively, in some embodiments, the PES support was kept in the drying oven at for a period of time of about 10 min. (6) The PES support was removed from the drying oven and was subsequently activated via UV-induced activation to produce an allylamine PES functionalized support. A UV lamp (Blak-Ray B-100A, high intensity UV lamp, 100 W, 365 nm wavelength) was placed at about 1 inch of the PES support. The PES support was illuminated with the UV lamp for a time interval of about 5 min to produce the allylamine PES functionalized support.

### Example 4. (4-Penten-1-Ol PES Functionalized Support)

A functionalized support was produced according to the following procedure: (1) A polyethersulfone (PES) support was exposed to a cleaning solution, with the cleaning solution being water. The PES support was soaked in the cleaning solution for a period of time of about 48 hours. (2) The PES support was subsequently dried at room temperature for a drying time of about 24 hours. (3) A monomer solution including 4-penten-1-ol monomer and water solvent was prepared by mixing a suitable amount of 4-penten-1-ol monomer in water, producing a 300 mM 4-penten-1-ol monomer solution. The PES support was disposed in the 4-penten-1-ol monomer solution in a petri dish. (4) The PES support was removed from the 4-penten-1-ol monomer solution in the petri dish and excess 4-penten-1-ol monomer solution was poured off from the PES support such that the PES support was only wetted in the 4-penten-1-ol monomer solution. (5) The PES support was subsequently dried by disposing the PES support in a drying oven at a predetermined temperature of between 11° and 120° C. for a period of time of about 10 min. (6) The PES support was removed from the drying oven and was subsequently activated via UV-induced activation to produce a 4-penten-1-ol PES functionalized support. A UV lamp (Blak-Ray B-100A, high intensity UV lamp, 100 W, 365 nm wavelength) was placed at about 1 inch of the PES support. The PES support was illuminated with the UV lamp for a time interval of about 5 min to produce the 4-penten-1-ol PES functionalized support.

### Example 5. (Allylamine PES Functionalized Support)

A functionalized support was produced according to the following procedure: (1) A polyethersulfone (PES) support was exposed to a cleaning solution, with the cleaning solution being water. The PES support was soaked in the cleaning solution for a period of time of about 48 hours. (2) The PES support was subsequently dried at room temperature for a drying time of about 24 hours. (3) A monomer solution including allylamine monomer and water solvent was prepared by mixing a suitable amount of allylamine monomer in water, producing a 300 mM allylamine monomer solution. The PES support was disposed in the allylamine monomer solution in a petri dish. (4) The PES support was removed from the allylamine monomer solution in the petri dish and excess allylamine monomer solution was poured off from the PES support such that the PES support was only wetted in the allylamine monomer solution. (5) The PES support was subsequently dried by disposing the PES support in a drying oven at a predetermined temperature of between 11° and 120° C. for a period of time of about 10 min. (6) The PES support was removed from the drying oven and was subsequently activated via UV-induced activation to produce an allylamine PES functionalized support. A UV lamp (Blak-Ray B-100A, high intensity UV lamp, 100 W, 365 nm wavelength) was placed at about 1 inch of the PES support. The PES support was illuminated with the UV lamp for a time interval of about 5 min to produce the allylamine PES functionalized support.

1. A functionalized support, comprising:
a polymeric membrane; and
a plurality of surface functional groups disposed on the polymeric membrane, the plurality of surface functional groups covalently bound to the polymeric membrane,
wherein the functionalized support is characterized by a NaCl rejection rate of at least 70% with a 1 wt. % NaCl solution at room temperature and a pressure of at least about 200 psi.

2. The functionalized support of claim 1, wherein the plurality of surface functional groups is covalently bound to the polymeric membrane via graft co-polymerization reactions of a monomer.

3. The functionalized support of claim 2, wherein the monomer includes at least one of an allyl group, a vinyl group, a benzyl group, or a cyclic olefin.

4. The functionalized support of claim 2, wherein the polymeric membrane includes polyethersulfone and the monomer includes allylamine.

5. The functionalized support of claim 4, wherein the plurality of surface functional groups is disposed on the polymeric membrane forming local surface clusters with a concentration of nitrogen of at least about 0.6 atomic percent (at %).

6. The functionalized support of claim 1, wherein the polymeric membrane is a microporous polymer substrate having a molecular weight cutoff (MWCO) of about 140 Da.

7. The functionalized support of claim 1, further comprising:
a graphene oxide membrane disposed on a surface of the polymeric membrane, the graphene oxide membrane comprising a plurality of graphene oxide layers, each graphene oxide layer including at least one graphene oxide sheet covalently coupled to a chemical spacer.

8. A filtration apparatus, comprising:
a functionalized support; and
a graphene oxide membrane disposed on the functionalized support, the graphene oxide membrane comprising a plurality of graphene oxide layers, each graphene oxide layer including at least one graphene oxide sheet covalently coupled to a chemical spacer,
wherein the filtration apparatus is characterized by a NaCl rejection rate of at least 70% with a 1 wt. % NaCl solution at room temperature and a predetermined pressure.

9. The filtration apparatus of claim 8, wherein the functionalized support includes:
a polymeric membrane including polyethersulfone; and
a plurality of surface functional groups, the plurality of surface functional groups covalently bound to the polyethersulfone.

10. The filtration apparatus of claim 9, wherein the plurality of surface functional groups are covalently bound to the polyethersulfone via UV-induced graft co-polymerization of a monomer.

11. The filtration apparatus of claim 10, wherein the monomer includes allylamine, and the plurality of surface functional groups is disposed on the polymeric membrane forming local surface clusters with a concentration of nitrogen of at least about 0.6 atomic percent (at %).

12. The filtration apparatus of claim 9, wherein the polymeric membrane is a microporous polymer substrate with a molecular weight cutoff (MWCO) of about 140 Da.

13. The filtration apparatus of claim 8, wherein the filtration apparatus has a permeance of at least 0.1 LMH with a 1 wt. % NaCl solution at room temperature and a pressure of at least 200 psi.

14. The filtration apparatus of claim 8, wherein the predetermined pressure is at least about 200 psi and no more than 1200 psi.

15. A method for preparing a functionalized support, including:
exposing a support material to a cleaning solution, the support material including polymeric membrane including polyethersulfone;
drying the support material at a predetermined temperature;
exposing the support material to a solution including one or more monomers; and
activating the support material to initiate a graft co-polymerization reaction of the monomer to produce a functionalized support having a plurality of surface functional groups covalently bound to the polyether sulfone.

16. The method of claim 15, wherein the one or more monomers include at least one of an allyl group, a vinyl group, a benzyl group, or a cyclic olefin.

17. The method of claim 15, wherein the activation step includes exposing the support material and the one or more monomers to Ultraviolet (UV) light for a period of time of no more than about 5 min.

18. The method of claim 15, wherein the activation step includes exposing the support material and the one or more monomers to a high energy treatment for a period of time of no more than about 5 min, the high energy treatment including at least one of a corona discharge, ozone, electron beam, or plasma.

19. The method of claim 15, wherein the one or more monomers include allylamine, and the and the plurality of surface functional groups is disposed on the polymeric membrane forming local surface clusters with a concentration of nitrogen of at least about 0.6 atomic percent (at %).

20. The method of claim 15, wherein the functionalized support is characterized by a NaCl rejection rate of at least 70% with a 1 wt. % NaCl solution at room temperature and a pressure of at least about 200 psi.

21. The method of claim 20, wherein the functionalized support is characterized by a NaCl rejection rate of at least 20% with a 1 wt. % NaCl solution, and a N₂SO₄ rejection rate of at least 90% with a 1 wt. % Na₂SO₄ solution, at room temperature and a pressure of at least about 200 psi.
